(19) United States
(12) Patent Application Publication
(10) Pub. No.: US 2026/0008673 A1
(43) Pub. Date: Jan. 8, 2026

(54) APPARATUS AND METHOD FOR PRODUCING GRAPHENE AND HYDROGEN

(71) Applicant: Levidian Nanosystems Limited, Cambridge (GB)

(72) Inventors: Krzysztof Kazimierz KOZIOL, Cambridge (GB); Karol BIELICKI, Cambridge (GB); Lukasz ZAKRZEWSKI, Cambridge (GB); Oliver WALKER, Cambridge (GB); Ian HOPKINS, Cambridge (GB)

(73) Assignee: Levidian Nanosystems Limited, Cambridge (GB)

(21) Appl. No.: 18/993,213

(22) PCT Filed: Jul. 11, 2023
(86) PCT No.: PCT/GB2023/051818

§ 371 Date: Jan. 10, 2025

(30) Foreign Application Priority Data
Jul. 12, 2022 (GB) 2210245.3

(51) Int. Cl. C01B 3/26; C01B 32/184

(52) U.S. Cl. CPC C01B 3/26; C01B 32/184; C01B 2203/04; C01B 2203/0861; C01B 2203/1235; C01B 2203/1638

(57) ABSTRACT

A portable containerised apparatus for producing hydrogen and graphene from a hydrocarbon source, the apparatus comprising: a plasma reactor system configured to produce hydrogen and graphene from a process gas comprising hydrocarbons; an inlet for receiving a feed stream comprising hydrocarbons from the hydrocarbon source and means for supplying the process gas to the plasma reactor system; a hydrogen outlet for removing hydrogen from the containerised apparatus and/or hydrogen storage means within the containerised apparatus, and means for providing a hydrogen-containing output gas from the plasma reactor system to the hydrogen outlet and/or the hydrogen storage means; and a graphene outlet for removing graphene-containing solids from the containerised apparatus and/or graphene storage means within the containerised apparatus, and means for providing graphene-containing solids from the plasma reactor system to the graphene outlet and/or the graphene storage means. Also provided is a method of producing hydrogen and graphene using such an apparatus.

The present invention relates generally to apparatuses, methods and systems for producing hydrogen and graphene from hydrocarbons. In particular, the present invention relates to a portable containerised apparatus for producing hydrogen and graphene from a hydrocarbon source and methods of operating such apparatus. The present invention also relates to plasma reactor systems for a portable containerised apparatus, modular systems comprising a portable containerised plasma reactor module, systems for producing reduced-carbon gas blends and systems for transporting graphene.

### BACKGROUND

There is currently a worldwide focus on reducing harmful emissions from the combustion or release of hydrocarbon fossil fuels, including gaseous hydrocarbons such as methane. Whilst alternatives to hydrocarbon fuels such as hydrogen can offer more environmentally friendly options, alternative fuels are typically difficult to integrate and distribute within existing infrastructure on a large scale without costly redevelopment or transportation of pressurised gas. In addition, hydrogen is currently synthesised by the catalytic cracking of hydrocarbon molecules or by electrolysis of water, which require a substantial input of heat or electrical energy, usually derived from fossil fuels. In this way, hydrogen as it is currently produced can in many cases not be considered as reducing harmful emissions when its production and transportation are taken into account.

Problems with existing technologies for using hydrocarbon gases to produce cleaner fuels leads to hydrocarbon gases such as methane being either combusted (for example during flaring of excess methane) to produce CO₂ or simply released into the atmosphere. This can be a particular problem at remote locations, where it may be uneconomical to set-up and use carbon capture technology for what might be only a temporary time period due to a leak or an unplanned excess of fuel. Such occurrences may also not be in a location that was planned in advance, for example in the case of a gas leak in a pipeline network spanning large distances or an unplanned excess of fuel at a specific point of use.

Accordingly, there is a need to find ways to manage hydrocarbon fuels whilst minimising release of CO₂ or hydrocarbons into the atmosphere.

A plasma-based system disclosed in WO 2012/023858 A1 was shown to produce hydrogen from hydrocarbon gases using an arrangement of plasma nozzles. However, such plasma systems are technically relatively complex relative to combustion systems and so require qualified personnel to assemble and operate them safely. The system also produces solid carbon by-products, which, whilst providing a carbon sink to address the problem of CO₂ release during combustion of hydrocarbon gases, must still be removed, potentially incurring additional cost.

A different plasma-based system is disclosed in WO 2015/189643 A1 and was demonstrated to produce graphene from hydrocarbon gases including methane. Graphene is considered to be a valuable material with great potential due to its many advantageous properties including exceptional mechanical properties (high strength and elasticity), high electrical and thermal conductivity, impermeability to gases and transparency to light. However, the system also produces gaseous by-products that may not be easily or economically useable in the location in which graphene production is performed.

Accordingly, there is a need to address the above-described problems.

### SUMMARY

An aspect of the invention provides a portable containerised apparatus for producing hydrogen and graphene from a hydrocarbon source, the apparatus comprising: a plasma reactor system configured to produce hydrogen and graphene from a process gas comprising hydrocarbons; an inlet for receiving a feed stream comprising hydrocarbons from the hydrocarbon source and means for supplying the process gas to the plasma reactor system; a hydrogen outlet for removing hydrogen from the containerised apparatus and/or hydrogen storage means within the containerised apparatus, and means for providing a hydrogen-containing output gas from the plasma reactor system to the hydrogen outlet and/or the hydrogen storage means; and a graphene outlet for removing graphene from the containerised apparatus and/or graphene storage means within the containerised apparatus, and means for providing graphene-containing solids from the plasma reactor system to the graphene outlet and/or the graphene storage means.

By providing a portable containerised apparatus, it is possible to provide the capacity to convert hydrocarbons into hydrogen gas and graphene at any location on short notice. For example, the portable containerised apparatus may be economically provided at a location where an excess of hydrocarbon fuel is temporary, such as in the case of an unplanned excess of fuel relative to energy demand, or at the site of a leak. As the apparatus is containerised and portable, it can be deployed without the need to build a fixed system at the point of use and so if and when the apparatus is no longer required at a particular location, it can be easily relocated to an alternative site for use or storage. In this way, the portable containerised apparatus can be deployed where needed according to hydrocarbon supply and demand to avoid environmentally harmful release or combustion of hydrocarbons (for example release of methane or CO₂ into the atmosphere).

As the plasma reactor system can be easily switched on and off without substantial start-up time or energy cost, the apparatus may also be economically operated on-demand as needed at a particular point of use. For example, excess electrical energy in an energy grid network can be provided to the apparatus for producing hydrogen and graphene. The apparatus can also be deployed to use excess energy generated at a source where continuous energy generation is performed for economic or technical reasons, but demand varies, for example during operation of a nuclear power station, such as a small modular nuclear reactor. In this way, by use of the containerised apparatus described herein, such energy generation processes can be continuously operated, whilst utilising excess energy to decarbonise hydrocarbon fuels whilst producing valuable carbon-based solid products (i.e., to convert at least a portion of the hydrocarbons into graphene and hydrogen gas, which can be used for energy generation or released). In addition, by using multiple containerised apparatuses to utilise excess electrical energy, very fast use of large amounts of energy can be achieved, which may help to address problems of balancing energy supply and demand in an energy grid network, whilst also producing valuable products and reducing carbon emissions.

In addition, natural gas supplies, containing primarily methane, are widely available via existing infrastructure, and so the portable containerised apparatus may be conveniently deployed for hydrogen production at a location where the hydrogen is used without requiring transportation of pressurised hydrogen or new fixed infrastructure suitable for distributing hydrogen. Furthermore, complete dissociation of hydrogen from methane requires only 1665 KJ/mol versus 1850 KJ/mol to release an equivalent amount of hydrogen from water molecules. Thus, in addition to repurposing natural gas to avoid release or combustion of methane, generating hydrogen using methane as the source of hydrogen requires 11% less energy compared to producing hydrogen from water.

The portable containerised apparatus can also produce graphene at the same time as decarbonising hydrocarbon streams. As will be appreciated, graphene is considered to be a valuable material due to its many advantageous properties. In this way, while decarbonising hydrocarbons such as natural gas, the solid carbon product produced in addition to hydrogen gas is a valuable commodity. This can provide additional economic benefits to using the apparatus, as when used for hydrogen production or decarbonisation of hydrocarbons such as natural gas is performed, the graphene can be collected and sold rather than potentially incurring cost to remove and transport less valuable carbon solids that may be produced in other plasma-based systems for generating hydrogen from hydrocarbons. Where the apparatus is moved between locations to make use of available hydrocarbon supplies, the graphene may be stored in the apparatus and transported from a single location only when necessary. In addition, where graphene production is the primary goal, the apparatus can be used to generate graphene whilst also decarbonising hydrocarbon fuels such as natural gas at the same time.

The apparatus is a portable containerised apparatus. Thus, the apparatus is not fixed in place, but can be moved and delivered as a whole to a desired location. The apparatus is portable and containerised in the sense that the apparatus is contained within or as part of a container, for example the apparatus can be set up in advance and delivered to a point of use, where only minimal or no further configuration is required for the apparatus to be used. In this way, construction of complex apparatus on-site at a point of use can be avoided. For example, the portable containerised apparatus may be deployed conveniently at a source of hydrocarbons such as at a location on a natural gas pipeline or network, a refinery, a power plant, an offshore rig and so on.

The container with which the apparatus is provided may be any suitable container for allowing the apparatus to be transported between locations. For example, the apparatus may comprise an intermodal container such as are commonly used for transporting goods, such as a shipping container. For example, the container may comprise an intermodal container conforming to an international standard size for shipping, such as ISO standard 668:2020. The container may for example have an external length of from 20 feet to 45 feet, preferably from 20 feet to 40 feet, such as a 20 foot or 40 foot long container. For example, the container may have an external length of 45 feet or less, preferably 40 feet or less. In some embodiments, a smaller apparatus may use a container having an external length of about 10 feet. The container suitably has an external width of 10 feet or less, for example an 8 foot wide container. The external height of the container is suitably 12 feet or less, preferably 10 feet or less, for example 9 feet 6 inches, 8 feet 6 inches or 8 feet. Preferably the container has an external height of at least 9 feet, for example 9 feet 6 inches, such as an intermodal container according to ISO designation 1EEE, 1AAA, 1BBB or 1CCC of ISO standard 668:2020. The internal dimensions of the container may vary but preferably the container has an internal length of from 19 feet to 45 feet, for example from 19 feet 3 inches to 44 feet 5 inches or preferably from 19 feet 3 inches to 39 feet 5 inches. It will also be appreciated that the apparatus may in some instances comprise more than one container housing different parts of the apparatus, where the containers can be joined together for transportation and/or at a point of use as is known in the art for shipping containers, for example using twist locks and twist lock fittings at the corners of each container.

It will be appreciated that components of the apparatus may be housed or contained within the container or may form a part of the container in the sense that they protrude through or form part of the container housing, such as an inlet for receiving a feed stream, or an outlet for removing hydrogen-containing output gas or graphene-containing solids from the container. In some embodiments, such inlets and outlets may be accessible via other openings on the container, for example by opening one or more doors on the container so that when the openings are closed, the container has the external profile and appearance of a conventional container. Preferably, the elements of the apparatus are contained within the container unless otherwise specified. The container may comprise one or more doors for providing access to the interior of the container. The doors may suitably be provided through one or more side walls of the container. Typically, the container will comprise doors at its end walls (i.e. the side walls at each end of the length of the container), but may also comprise one or more doors in its side walls connecting each end wall. In some preferred embodiments, the container comprises one or more internal dividing walls configured to separate the interior of the container into separate compartments. For example, one or more dividing walls may be present to isolate an area in which gases such as hydrogen, methane or inert gases are stored at high pressure from the remainder of the container, for example to isolate an area in which compressed gases are stored from a user interface inside the container with which a user can operate or monitor the apparatus, which can reduce the danger to a user inside the apparatus. A dividing wall may isolate an area in which gases are stored (e.g. under pressure), or in which gases are supplied into the container (e.g. the inlet for receiving the feed stream), from the plasma reactor system, which may aid in detecting leaks from the plasma reactor system.

As described, the apparatus can produce hydrogen and graphene using hydrocarbons from a hydrocarbon source. The hydrocarbons may be any suitable hydrocarbons and it will be appreciated that the hydrocarbons should be suitable for providing to the plasma reactor system in the process gas, for example the hydrocarbons in the feed stream and the process gas are preferably a hydrocarbon gas. For example, the hydrocarbons are preferably gaseous under ambient conditions, for example at around atmospheric pressure and from 15° C. to 30° C. Preferably the hydrocarbons in the feed stream and in the process gas comprise or consist essentially of one or more of CH₄, C₂H₆, C₂H₄, C₃H₈ or C₄H₁₀, for example the feed stream or the process gas may comprise or consist essentially of one or more of CH₄, C₂H₆, C₂H₄, C₃H₈ or C₄H₁₀. Preferably, the hydrocarbons comprise or consist essentially of natural gas or methane (CH₄), for example the feed stream to the apparatus may comprise or consist essentially of natural gas or methane. Similarly, the process gas may comprise or consist essentially of natural gas or methane. As will be appreciated, natural gas is well known in the art and typically comprises more than about 80% v/v of methane, and smaller amounts of other hydrocarbons such as ethane, propane and butane, and may also contain small amounts of non-hydrocarbon gases such as nitrogen, CO₂, argon or other noble gases, and sulfur-containing gases such as H₂S, where in some instances the non-hydrocarbon and/or the non-methane hydrocarbons may have been removed or reduced by refining prior to being provided to the apparatus in the feed stream. In some embodiments, undesired gases or particulates such as aerosols in the feed stream may be removed by one or more filters arranged to filter the feed stream.

It will be appreciated that the hydrocarbons in the feed stream received at the inlet are provided to the plasma reactor system in the process gas. In preferred embodiments, the process gas provided to the plasma reactor system may consist essentially of the feed stream comprising hydrocarbons, for example the apparatus may preferably receive a feed stream comprising hydrocarbons and direct the feed stream into the plasma reactor system as the process gas, for example without changing the composition of the feed stream such as by blending with other gases.

Whether the feed stream is provided as the process gas or only a portion of the process gas, the feed stream is preferably regulated to provide the process gas at a predetermined pressure and/or flow rate into the plasma reactor system. Preferably, the apparatus comprises a regulator system configured to receive the feed stream comprising hydrocarbons and to control the pressure of the feed stream to provide the process gas to the plasma reactor system at a selected pressure, for example at substantially atmospheric pressure (although higher pressures may be used in some embodiments). The regulator system may additionally be configured to control the flow rate of the process gas into the plasma reactor system. The regulator system allows the apparatus to be flexibly used with different sources of hydrocarbons without needing to reconfigure or redesign the apparatus, such as the plasma reactor system, for use with higher pressure feed gas or lower pressure feed gas than is required. Thus, the regulator system can allow the apparatus to be used with feed gas sources as different pressures depending on the desired application, for example the pressure of natural gas provided to the apparatus may vary depending on whether the source is from a distribution network for natural gas, a pipeline leak site, a refinery, a power plant etc. This can allow a single design of apparatus to be used in multiple different situations. In some embodiments, external pressure and flow regulation may instead be performed to provide the feed stream to the apparatus as required.

In preferred embodiments, the apparatus comprises a feed pressure sensor configured to determine the pressure of the feed stream, wherein the regulator system is configured to regulate the feed stream pressure to provide the process gas based on the sensed feed pressure. The regulator system may comprise a compression means for increasing the pressure of the feed stream and a pressure reduction means for reducing the pressure of the feed stream, where the regulator system may be operable to direct the feed stream to the compression means or the pressure reduction means based on the pressure of the feed stream, for example based on whether a sensed pressure of the feed stream is above or below a predefined threshold pressure. The regulator system may be configured to receive the feed stream at a particular pressure in order to store or to provide the process gas at the desired pressure. For example, the regulator system may be configured to receive a feed stream at a pressure of from 2 bar to 25 bar, such as about 3 bar to 18 bar, in order to store the incoming feed gas and/or provide the process gas at about atmospheric pressure. Thus, the regulator system may be configured to compress the feed stream with the compression means if the pressure is below 3 bar, for example below 2 bar, and the regulator system may be configured to reduce the pressure of the feed stream with the pressure reduction means if the pressure is above 18 bar, for example above 25 bar.

In some instances, for example where there is an excess of hydrocarbons available in the feed stream compared to the hydrocarbons necessary to provide a desired flow rate of the process gas, or where the feed stream is at a pressure that is lower than is required by the apparatus, the apparatus may be configured to store hydrocarbon gas within the apparatus, for example the regulator system may be configured to store a portion of the feed stream within the apparatus for providing to the plasma reactor system as at least a portion of the process gas at a later time, for example the regulator system may be configured to pressurise at least a portion of the feed stream for storage. Thus, the hydrocarbon source preferably comprises an external source of hydrocarbons and/or hydrocarbon storage means within the containerised apparatus. The hydrocarbon storage means may suitably be configured to store hydrocarbons received from an external source of hydrocarbons and to provide the stored hydrocarbons to the plasma reactor in the process gas. In this way, the apparatus may allow continuous and consistent operation even with an inconsistent hydrocarbon feed to the apparatus by providing additional feed gas from hydrocarbon storage to supplement or replace the feed stream when there is a deficiency of supply and storing hydrocarbons in hydrocarbon storage means when there is an excess of supply. Storing hydrocarbons under pressure can also allow the apparatus to control the supply of the process gas by only drawing the process gas from the storage means at a defined pressure, and replenishing the storage means with hydrocarbons using the feed stream. The hydrocarbon storage means may comprise any suitable means for storing gases, for example storage under pressure in one or more gas cylinders as known in the art, for example at a pressure of from about 10 bar to 200 bar, such as from about 10 bar to 100 bar, about 10 bar to 50 bar, for example from about 15 bar to 25 bar. In some preferred embodiments, the apparatus may comprise one or more pressure sensors configured to sense the pressure of an incoming feed stream, wherein the apparatus is configured to store excess hydrocarbons or, where available, supplement the feed stream with stored hydrocarbons depending on the sensed pressure of the feed stream.

The plasma reactor system is configured to receive the process gas comprising hydrocarbons, for example natural gas or methane, and to produce hydrogen and graphene. Preferably, the plasma reactor system comprises a reaction chamber, a plasma nozzle coupled to the reaction chamber, and means for supplying the process gas to the plasma nozzle.

The plasma reactor system may comprise means for providing radio frequency radiation to the process gas within the plasma nozzle so as to produce a plasma within the plasma nozzle, and thereby cause cracking of hydrocarbons in the process gas within the plasma nozzle to provide cracked hydrocarbon species, wherein the plasma nozzle is arranged such that an afterglow of the plasma extends into the reaction chamber, the cracked hydrocarbon species also pass into the reaction chamber and recombine within the afterglow to provide graphene and hydrogen in the reaction chamber. The plasma nozzle configuration is described in more detail elsewhere in the disclosure, and an example of a plasma reactor comprising a plasma nozzle coupled to a reaction chamber that may be used to produce graphene and hydrogen is described in WO 2015/189643 A1.

Preferably, the reaction chamber of the plasma reactor system comprises a gas outlet configured to receive a hydrogen-containing output gas from the reaction chamber and a planar filter element arranged to separate the reaction chamber from the gas outlet, wherein the planar filter element is configured to prevent graphene-containing solids from entering the gas outlet. The use of a planar filter element allows the plasma reactor system to efficiently separate the graphene containing solids produced in the reaction chamber from the hydrogen-containing output gas whilst reducing the size of the apparatus in comparison to previously used filters such as candle filters. This advantageously allows the plasma reactor system to be reduced in size for operation within a containerised apparatus having limited space without reducing the size of the reaction chamber and sacrificing product output or quality. In addition, the planar filter element may be conveniently cleaned to remove solids deposited on the filter by a scraper system instead of requiring the blowing of gas in reverse through the filter to dislodge deposits. In this way, the plasma reactor system can be continuously operated without the need to shut down or disrupt operation of the plasma reactor system to clean the filter with blown gas, and the means for providing a back-flow of gas through the filter may be omitted to reduce the cost, size and weight of the plasma reactor system.

Preferably, the planar filter element is disposed above the reaction chamber. For example, the reaction chamber may comprise an upper end and a lower end separated by one or more lateral or side walls, where the gas outlet and the planar filter element are disposed at the upper end of the reaction chamber. The gas outlet and/or the planar filter element may for example be disposed on a side wall of the reaction chamber at its upper end, or preferably may be disposed on or forming an upper wall of the reaction chamber. For example, in preferred embodiments the planar filter element extends across the reaction chamber to provide an upper wall of the reaction chamber. This arrangement of the planar filter element at an upper end of the reaction chamber, for example to provide an upper wall of the reaction chamber, can permit a significant reduction in size of the apparatus compared to other filtration systems or configurations, such as candle filters. In addition, a filter element configured to provide an upper wall of the reaction chamber provides a large surface area for filtration and may allow pressure inside the reaction chamber to be reduced whilst maintaining flow, and may allow the lifetime of the filter to be extended. The planar filter element may also be scaled in size with a reaction chamber (for example by increasing diameter or cross section of the reaction chamber), whilst requiring only a small additional height above the reaction chamber.

In preferred embodiments, the reaction chamber has a substantially flat upper wall. Preferably the planar filter element provides at least a portion of the flat upper wall of the reaction chamber, for example the planar filter element may extend across the reaction chamber to provide the substantially flat upper wall of the reaction chamber. In this way, the flat upper wall of the reaction chamber comprising the filter element may be conveniently cleaned to remove solids deposited on the filter/upper wall by a simple scraper system, which would not be possible when using other filter types such as candle filters. In embodiments, the planar filter provides at least a substantial portion of the flat upper wall of the reaction chamber, for example at least 50% of the flat upper wall of the reaction chamber, preferably at least 70%, more preferably at least 80%, such as at least 90% of the flat upper wall of the reaction chamber. For example, the flat upper wall of the reaction chamber may be provided entirely by the planar filter element.

The planar filter element may preferably comprise a filtration means and a filter volume separating the filtration means from the gas outlet, the filter volume arranged above the filtration means to maintain an elevated temperature around the filtration means. For example, where the filter element provides an upper wall of the reaction chamber, the filtration means provides a gas permeable wall above the reaction chamber to prevent the passage of solids, and the filter element comprises an outer wall above the filtration means, the outer wall comprising the gas outlet. The filter volume may be disposed between the filtration means and the outer wall of the filter element to provide a chamber between the filtration means and the gas outlet. In this way, hot gases from the reaction chamber that pass through the filtration means can maintain an elevated temperature (for example at least about 50° C., such as about 50° C. to 300° C., preferably about 60° C. to 200° C., for example about 70° C. to 150° C., for example about 75° C. to 95° C.) around the filtration means to reduce or prevent precipitation of vapours on the filtration means. Preferably, the filter volume is arranged so as to promote flow of gas evenly though the surface of the filtration means, for example the upper wall may be substantially parallel with the filtration means. Nonetheless, if the filter volume above the filtration means is too large, gases may cool above the filtration means and cause precipitation of solid or liquid material on the filtration means. Thus, the volume of the filter volume above the filtration means is preferably selected to promote even flow of gas through the filtration means across its surface, whilst avoiding precipitation of vapours on the filtration means. The height of the filter volume (i.e. the distance between the filtration means and the outer wall) may suitably be from about 0.5 cm to about 5 cm, preferably from about 1 cm to 2 cm (and in some embodiments with smaller reaction chambers may be as small as about 1 mm). Nonetheless, it will be appreciated that the height of the filter volume may suitably be varied depending on the size of the reaction chamber and the parameters under which the plasma reactor system is operated.

The filtration means may be any suitable material for filtering solids from gas at elevated temperatures. The filtration means may comprise a porous material formed from fibres, such as metal fibres. For example, the filtration means may be formed from metal fibres such as stainless steel or Hastelloy. The thickness of the filtration means may vary depending on the specific requirements of the system, but may in some embodiments have a thickness of about ⅛ inch (3.175 mm), for example from about 1/32 inch (0.794 mm) to ½ inch (12.7 mm), such as from about 1/16 inch (1.588 mm) to ¼ inch (6.35 mm). The filtration means may be configured to remove from the gas particles having a minimum size of from about 1 μm to 100 μm, for example from about 1 μm to 50 μm, such as from about 1 μm to 20 μm or from about 5 μm to 15 μm. For example, the pore diameter of the filtration means may be from about 1 μm to 100 μm, for example from about 1 μm to 50 μm, such as from about 1 μm to 20 μm or from about 5 μm to 15 μm. The filtration means may suitably have the same dimensions such as diameter as the reaction chamber so as to provide an upper wall of the reaction chamber. In some preferred embodiments, the filtration means has a filtration area of about 0.2 m² to 4 m², for example from about 0.25 m² to 3.5 m², such as from about 0.3 m² to 3.2 m².

Due to positive pressure in the reaction chamber, the filtration means may deform under pressure, reducing efficiency and/or causing mechanical fatigue and reducing the lifetime of the filter. Therefore, the filter element may also comprise a filter support configured to reduce or prevent deformation of the filtration means under pressure from the reaction chamber. For example, the filter support may comprise a plurality of support struts arranged to support the filtration means without substantially impeding passage of gas through the filtration means, for example in the form of a mesh disposed above the filtration means. The support struts may for example comprise one or more radially extending portions and one or more concentric circular portions intersecting the one or more radially extending portions. The filter support can maintain the filtration means in a substantially flat configuration during operation of the plasma reactor system, facilitating convenient removal of solid deposits from the lower surface of the filtration means with a simple scraping system.

Preferably, the reaction chamber comprises a graphene removal port and the reactor system may comprise a hopper configured to receive graphene-containing solids from the reaction chamber through the graphene removal port. The graphene removal port is preferably disposed below the reaction chamber such that graphene-containing solids in the reaction chamber can pass from the reaction chamber through the graphene removal port under gravity, for example into the hopper. The reaction chamber may be configured to direct graphene-containing solids through the graphene removal port. For example, the walls of the reaction chamber may be shaped and arranged so as to direct graphene-containing solids towards the graphene removal port under gravity. Preferably the reaction chamber is tapered towards the graphene removal port, for example the reaction chamber may comprise a substantially conical portion at its lower end that narrows the reaction chamber towards the graphene removal port.

The graphene removal port preferably comprises a separation valve configured to close the graphene removal port, for example a separation valve configured to isolate the reaction chamber from the hopper. In this way, the reaction chamber may be isolated from graphene-containing solids that have exited the reaction chamber via the graphene removal port, allowing the plasma reactor system to continue operation to produce hydrogen and graphene without interruption whilst graphene-containing solids can be collected, for example to the graphene storage means or via the graphene outlet of the apparatus.

Preferably, the separation valve provides a surface on which graphene-containing solids in the reaction chamber can collect when the separation valve is closed, to permit graphene-containing solids to continue to accumulate, for example whilst the hopper is emptied. The separation valve is then preferably configured to permit the collected graphene-containing solids to pass through the graphene removal port, and enter the hopper, when the separation valve is opened. The separation valve may comprise any suitable valve, for example an orifice gate valve. The separation valve may comprise a gas purge assembly configured to provide pressure to prevent material build-up within the valve or leakage. Suitably, the separation valve may be configured to operate at a differential pressure of at least up to 1 bar.

In preferred embodiments, the apparatus comprises means for extracting graphene-containing solids from the hopper to the graphene storage means or the graphene outlet. For example, the means for extracting graphene-containing solids from the hopper may comprise means for causing the graphene containing solids to flow out of the apparatus via the graphene outlet. In some embodiments, graphene-containing solids may be caused to flow (for example in a carrier gas) by a system external to the apparatus, wherein the means for extracting graphene-containing solids from the hopper comprises a closable passage, for example having a valve, configured to permit graphene-containing solids to be drawn from the hopper to leave the apparatus via the graphene outlet. In preferred embodiments, the means for extracting graphene-containing solids from the hopper is configured to cause graphene-containing solids to flow, for example with a carrier gas, from the hopper to a graphene storage means within the apparatus.

The means for extracting graphene-containing solids from the hopper preferably comprises a gas-solid separator and a vacuum source configured to draw the gaseous suspension of graphene-containing solids to the gas-solid separator so that the gas passes to the vacuum source and the graphene-containing solids are separated from the gas and provided to graphene storage means. For example, the means for extracting graphene-containing solids from the hopper preferably comprises a cyclonic separator and a vacuum source configured to draw a gaseous suspension of the graphene-containing solids from the hopper to the cyclonic separator. The cyclonic separator is preferably configured to induce a circulatory flow of the gaseous suspension of the graphene-containing solids around a separation chamber of the cyclonic separator to distribute graphene-containing solids in the gaseous suspension radially outwards in the circulatory flow, for example towards a lateral or side wall of the cyclonic separator. In this way, the graphene-containing solids are concentrated around the periphery of the separation chamber. Thus, the vacuum source may be configured to draw gas into a gas outlet port from a central volume of the separation chamber surrounded by the circulatory flow, the central volume containing a reduced proportion of the graphene-containing solids relative to the gaseous suspension of the graphene-containing solids from the hopper. Preferably, a lateral or side wall of the separation chamber is tapered towards an outlet for providing graphene-containing solids from the separation chamber to the graphene storage means. The separation chamber may suitably have an upper end and a lower end separated by a lateral or side wall, wherein the lateral or side wall is curved, for example conical or cylindrical, to induce the circulatory flow.

While a reduced proportion of solids is present in the gas that is drawn from the cyclonic separator towards the vacuum source, it is preferred to avoid solids passing to the vacuum source, which may waste valuable solid products and could damage or inhibit the vacuum source. Thus, the vacuum source is preferably separated from the cyclonic separator by a vacuum filter, for example a candle filter (although any suitable filter may be used), preferably wherein the apparatus comprises means for blowing gas through the vacuum filter in reverse, to dislodge solids from the vacuum filter. The apparatus may be configured to perform this step of dislodging solids on the vacuum filter after collection of graphene-containing solids from the hopper, once the hopper is isolated from the vacuum system and cyclonic separator.

The vacuum source may comprise any suitable vacuum source, such one or more vacuum pumps as are well-known in the art.

As will be appreciated, a gas-solid separator and a vacuum source, such as the cyclonic separator described, may alternatively, or additionally, be provided as an external component to the apparatus for drawing graphene-containing solids out from the apparatus through a graphene outlet, such as from a hopper or a graphene storage means within the apparatus. For example, the present apparatus may comprise no cyclonic separator and vacuum system, and the graphene-containing solids can be drawn out from the graphene outlet using a separate means for extracting graphene-containing solids, such as a cyclonic separator and vacuum system disposed externally, such as in a further separate portable containerised apparatus. In other embodiments, the present apparatus may contain a cyclonic separator and vacuum system as described, wherein graphene-containing solids collected may then be extracted from the apparatus, for example from the graphene storage means, using an external vacuum system and cyclonic separator. An external extraction and separation system, for example comprising a vacuum system and cyclonic separator may be configured to extract graphene-containing solids from two or more separate portable containerised apparatuses as described herein.

The hopper may be any suitable design such that it can receive and hold graphene exiting the reaction chamber via the graphene removal port. For example, the hopper may comprise a chamber in which the graphene-containing solids can collect when the separation valve is open. The chamber may be sealable such that when the separation valve is open, the hopper is only open to the reaction chamber. The hopper may comprise a sealable chamber, for example where the hopper can be selectively isolated from the reaction chamber during collection of graphene-containing solids from the hopper, and isolated from the means for extracting graphene-containing solids from the hopper when the separation valve is open.

Preferably the hopper comprises one or more gas inlets for receiving a flow of air and/or inert gas. For example, the hopper may comprise a first gas inlet for receiving a carrier gas, such as air, for carrying the graphene-containing solids out from the hopper, for example towards a vacuum source and a cyclonic separator as described. In some embodiments, instead of a vacuum source, a carrier gas flow provided to the hopper may be used to carry the graphene-containing solids from the hopper to the graphene outlet or graphene storage means, where the carrier gas flow may optionally be separated from the graphene-containing solids by filtration or a cyclonic separator and provided to an outlet. That is, instead of providing a reduced pressure at a vacuum source to draw gas from the hopper, an elevated pressure may be provided at the hopper to provide a pressure gradient from the hopper to a lower pressure outlet downstream to convey the graphene-containing solids from the hopper. The hopper may comprise a second gas inlet for receiving an inert gas for purging air, particularly oxygen, from the hopper after graphene-containing solids have been removed from the hopper and before opening the separation valve. Thus, the hopper may also comprise an exhaust outlet for exhausting purge gas and air from the hopper. The hopper may also comprise an oxygen sensor, where the apparatus is configured to open the separation valve to the reaction chamber only in the event that the oxygen level in the hopper is below a threshold level.

Preferably, the apparatus is configured such that the time from closing the separation valve to extract graphene-containing solids from the hopper until the separation valve is reopened to resume collection is less than 10 minutes, preferably less than 5 minutes. In this time, the apparatus can close the separation valve, purge the hopper of flammable gases from the reaction chamber, extract the graphene-containing solids from the hopper, purge the hopper with inert gas, and reopen the separation valve.

The reaction chamber of the plasma reactor system may have any suitable shape and dimensions and it will be appreciated that the volume of the reaction chamber may be varied based on the operating parameters of the system, for example the flow rate of process gas through the plasma nozzle, the flow rate from the reaction chamber through the gas outlet and/or the pressure within the reaction chamber (which may suitably be controlled by controlling gas flow into and gas flow out from the reaction chamber). For example, the volume of the reaction chamber may be selected (e.g. based on the flow rates into the chamber through one or more plasma nozzles and flow rate out from the reaction chamber through the gas outlet, and/or pressure within the reaction chamber) to provide a gas temperature within the reaction chamber (for example at an upper end of the reaction chamber or at the filter element) of less than 200° C., for example less than 150° C. As will be appreciated, gas temperature within the reaction chamber will vary throughout its volume, and gas temperature within the reaction chamber as described will be understood as referring to the temperature of gases in the reaction chamber outside of the plasma afterglow exiting a plasma nozzle, which will typically be at a higher temperature. The reaction chamber may comprise an upper end and a lower end separated by one or more lateral or side walls, wherein one or more side walls can comprise one or more plasma nozzles coupled thereto as described herein.

In preferred embodiments, the reaction chamber comprises a substantially cylindrical portion having a curved side wall. In preferred embodiments, the plasma nozzle is disposed at a lower end of the reaction chamber, for example at the lower end of a curved side wall of a substantially cylindrical portion. With a gas outlet at the upper end of the reaction chamber, for example wherein the substantially cylindrical portion comprises a filter at its upper end (such as a planar filter element as defined previously) and a graphene removal port at the lower end of the reaction chamber, this arrangement can provide an advantageous configuration that supports the natural flow of the hot process gases, because the hot gases naturally flow up through the reaction chamber, for example through planar filter element to the gas outlet as described previously. The graphene-containing solids begin to rise up with the hot gases, and then, as the temperature within the reaction chamber drops, they begin to fall downwards towards the graphene removal port. Preferably, the reaction chamber comprises a collection volume in the reaction chamber separating the one or more plasma nozzles from the graphene removal port, for example below the plasma nozzle(s) on a side wall of the reaction chamber. In this way, the hot gases from recombination of cracked species in the plasma rise in the reaction chamber and the collection volume provides a lower temperature environment for collecting graphene, for example while the graphene removal port is closed, for example when the separation valve separating the reaction chamber from the hopper is closed. As described, the substantially cylindrical portion can comprise a graphene removal port at its lower end. For example, the reaction chamber may comprise a tapered portion, such as a substantially conical portion, extending down from the lower end of the substantially cylindrical portion to the graphene removal port. This can help to funnel the graphene-containing solids falling under gravity towards the graphene removal port, and can provide a lower temperature environment for temporary collection of graphene when the graphene removal port is closed.

The reaction chamber and the plasma reactor system may suitably have a modular structure to facilitate easier assembly and maintenance. For example, a reaction chamber may comprise or be provided by at least a separate substantially cylindrical portion, substantially conical portion, and a filter element as described herein, where these components are detachable from each other to permit access to the interior of the reaction chamber.

In general, the reaction chamber, such as the substantially cylindrical portion, may suitably have a diameter of from about 40 cm to 200 cm, such as from about 40 cm to 100 cm, for example from about 50 cm to 80 cm. As will be appreciated, the reaction chamber may be non-circular, and so the reaction chamber in preferred embodiments may have a horizontal width no greater than about 240 cm, for example no greater than about 200 cm, where width refers to the narrowest horizontal dimension of the reaction chamber. Thus, the reaction chamber may be configured so as to fit inside a container having a width of about 2.5 m or less, where the dimension down the length of the container may in some instances be greater than 2.5 m. In preferred embodiments, the height of the reaction chamber from a graphene removal port at its lower end to a gas outlet at its upper end is less than 2.0 m, for example less than 1.5 m (in some embodiments, the height may for example be as low as 0.1 m). For example, the height of a substantially cylindrical portion of the reaction chamber may be less than 1.0 m, for example from 0.6 m to 1.0 m. The height of a tapered portion at the lower end of the reaction chamber may preferably have a height (e.g. extending from the substantially cylindrical portion) of 0.5 m or less, for example from 0.2 m to 0.5 m. Thus, the volume of the reaction chamber may suitably be from about 0.001 m³ to 5 m³, such as from 0.2 m³ to 3 m³. Nonetheless, it will be appreciated that the exact dimensions of the reaction chamber may suitably be varied based on operating conditions and physical requirements of the container. Preferably, the volume of the reaction chamber, the pressure of the process gas, the pressure within the reaction chamber, the power provided to the plasma nozzle, and/or the number of plasma nozzles, may be selected to provide a gas temperature within the reaction chamber of less than 200° C., such as less than 150° C. For example, the volume of the reaction chamber may be selected to provide, during operation, a gas temperature within the reaction chamber of less than 200° C., such as less than 150° C., based on the desired flow of process gas into the plasma reactor system and the flow of gas out of the reaction chamber, as well as the power provided to the plasma nozzle(s) e.g. the desired productivity of the plasma reactor system to produce hydrogen and graphene.

In preferred embodiments, the plasma reactor system comprises a scraper system for removing material that is deposited on an internal wall of the reaction chamber. This reduces deposits of graphene-containing solids on the internal walls, which may otherwise build up and disrupt operation, for example requiring shut down of the reactor system to provide manual maintenance. In addition, the internal walls of the reaction chamber may retain heat and provide a hotter surface than, for example, at a lower end of the reaction chamber where graphene-containing solids are removed from the reaction chamber, or after removal from the reaction chamber. Thus, if graphene is deposited and trapped on the internal walls of the reaction chamber, it may be exposed to elevated temperatures for a longer period than would otherwise be the case. This prolonged exposure of the graphene to elevated temperatures (for example greater than 100° C., or greater than 130° C. such as greater than 150° C.) may degrade the graphene and reduce its quality. By providing a scraper system as described herein, the quality of graphene may be increased and interruptions of operation for maintenance may be reduced.

Preferably, the scraper system comprises a scraper arm configured to extend along, and contact, a lateral or side wall of the reaction chamber from an upper end to a lower end of the reaction chamber, wherein the scraper arm is operable to rotate about a longitudinal axis of the reaction chamber, for example to rotate about the longitudinal axis of a cylindrical portion of the reaction chamber, so as to move the scraper arm around the internal surface of the side wall.

Preferably the scraper arm extends along the internal walls of the reaction chamber from its upper end to its lower end so as to provide removal of deposited material on substantially all of the internal walls of the reaction chamber. For example, the scraper arm may extend radially from the centre of the upper wall of the reaction chamber, down the side walls to the graphene removal port. In this way, rotation of the scraper arm about a longitudinal axis, extending through the reaction chamber from its lower end to its upper end, can provide removal of deposited material on all of the internal walls of the reaction chamber. As described, the reaction chamber may comprise a substantially flat upper wall, which may be provided by a planar filter element, which can advantageously allow a scraper arm to remove deposits from the filter element by moving the scraper arm across the surface of the filter element. Thus, the reaction chamber may comprise a substantially cylindrical portion, and a substantially conical portion. Thus, the scraper arm may extend radially along the flat upper wall from the centre of the upper wall to the upper end of the cylindrical side wall, down the side wall, and down along the wall of the conical portion to the graphene removal port.

The portion of the scraper arm that extends down the side walls of the reaction chamber may be parallel with the axis of rotation of the scraper arm (for example parallel with the longitudinal axis of the cylindrical portion) or may be disposed at an angle from the axis of rotation such that the scraper arm extends from an upper end of the side wall, down the and circumferentially around the side wall to the graphene outlet. Preferably, the scraper arm extends parallel with the axis of rotation of the scraper arm so as to extend along the walls of the reaction chamber from an upper end to a lower end of the reaction chamber by the shortest path.

The scraper arm may comprise a contact portion configured to contact the internal walls of the reaction chamber, where the contact portion may be formed from a different material to a body of the scraper arm. For example, the scraper arm may comprise a substantially rigid and heat resistant material such as stainless steel or Hastelloy, while the contact portion may comprise a flexible and heat-resistant material such as silicone.

As described, the scraper arm may be rotated to move the scraper arm across the internal walls of the reaction chamber. The rotation of the scraper arm may be provided by any suitable means, such as a motor. In preferred embodiments, the scraper system comprises a motor disposed above the reaction chamber coupled through the centre of the upper wall of the reaction chamber to the scraper arm. The motor may comprise any suitable motor, preferably a rotary actuator that permits the use of position feedback to control its motion and final position, such as a servomotor. For example, in response to a signal to activate the scraper arm, the motor may be configured to perform one or more full rotations of the scraper arm so that the scraper arm ends in substantially the same position it started from. The scraper system preferably comprises an angular gearbox to permit a motor to be disposed horizontally at the upper end of the reaction chamber, which can reduce the vertical height of the plasma reactor system, aiding the provision of the system in a portable containerised apparatus.

In preferred embodiments, the reactor system comprises means for heating one or more internal walls of the reaction chamber to reduce or avoid precipitation of vapours that are present in the reaction chamber on the one or more internal walls of the reaction chamber.

Without wishing to be bound by any particular theory, it is believed that vapours in the reaction chamber, such as hydrocarbon species, cool and precipitate on the internal walls of the reaction chamber. This may then provide a surface on the internal walls on which graphene can accumulate or agglomerate, leading to increased deposition of graphene on the reaction chamber walls. By heating the internal walls of the reaction chamber, such precipitation may be reduced or avoided, thereby leading to reduced graphene deposition on the internal walls and reducing degradation. The means for heating one or more internal walls of the reaction chamber may suitably be configured to heat the walls to a temperature of from about 100 to 450° C., for example about 125 to 350° C., for example about 150 to 250° C. The reaction chamber walls may be heated to direct precipitation and deposition of solid material to the hopper, for example wherein the walls of the reaction chamber are heated to reduce precipitation, while a hopper in fluid communication with the reaction chamber is not heated.

Heating graphene to an elevated temperature will typically increase degradation and so heating the internal walls may therefore be expected to increase graphene degradation. However, surprisingly, by heating the internal walls and preventing precipitation of other vapour species in the reaction chamber, this can reduce accumulation of graphene on the walls to begin with, and overall reduce degradation and increase quality of graphene.

It will be appreciated that the means for heating one or more internal walls of the reaction chamber may suitably be combined with a scraper system as described herein to provide reduced graphene degradation, or may be provided without a scraper system in order to reduce the vertical size of the system (for example where a motor for a scraper system may otherwise be required above the reaction chamber).

The means for heating one or more internal walls of the reaction chamber may comprise any suitable means, for example one or more electric heaters (such as flexible electric heaters) or a heating collar (such as an oil heating collar) disposed on the outside of the reaction chamber. The temperature in the reaction chamber may also be controlled by controlling the flow rate of hydrogen-containing output gas from the reaction chamber, for example the flow rate of gas out from the process chamber may be reduced to increase the temperature within the reaction chamber. The means for heating one or more internal walls of the reaction chamber may in some preferred embodiments comprise a heat pipe system for distributing heat generated by the plasma reactor system around the internal walls of the reaction chamber. The heat pipe system may comprise any suitable configuration that may have a flat or curved shape to replace a part of an internal wall of the reaction chamber. For example, a heat pipe system configured to distribute heat provided by the recombination of cracked hydrocarbon species from the plasma nozzle around the internal walls of the reaction chamber. Such a heat pipe system may be configured to distribute heat from the internal walls of the reaction chamber adjacent the plasma nozzle, or from the plasma nozzle itself. By using heat generated by the plasma system, walls of the reaction chamber may be heated without expending, or whilst reducing, the energy required to heat the reaction chamber using electrical or heat collar systems.

Depending on the precise operating conditions, the hydrogen-containing output gas from the plasma reactor system may comprise hydrocarbons such as unreacted hydrocarbons from the process gas, for example the hydrogen-containing output gas may comprise methane. In order to provide a substantially carbon-free hydrogen gas, the hydrocarbons in the hydrogen-containing output gas may be recirculated and provided to the plasma reactor system in the process gas. Thus, the apparatus may comprise means for recirculating hydrocarbons in the hydrogen-containing output gas to the plasma reactor system, for example means for blending recirculated hydrocarbons into the process gas. The means for recirculating hydrocarbons in the hydrogen-containing output gas may be operable to control the proportion of hydrocarbons in the hydrogen-containing output gas that are recirculated to the plasma reactor system, for example in order to achieve a desired proportion of hydrogen or hydrocarbon gas provided by the apparatus. In some embodiments, the composition of the hydrogen-containing output gas may be monitored by flaring at least a portion of the hydrogen-containing output gas and monitoring the temperature with one or more thermocouples.

In some embodiments, alternatively or additionally to recirculation of hydrocarbons in the hydrogen-containing output gas as described herein, the plasma reactor system may be operated under conditions to avoid or reduce the presence of hydrocarbons in the hydrogen-containing output gas. For example, the flow rate or pressure of the process gas through the plasma nozzle and/or the power of radio-frequency radiation provided to the process gas in the plasma nozzle may be controlled to achieve increased conversion of hydrocarbons in the process gas (for example by increasing pressure, reducing flow rate or increasing power).

The apparatus may comprise a hydrogen separator configured to separate hydrogen in the hydrogen-containing output gas from hydrocarbons to provide to provide a hydrogen product stream and a hydrocarbon product stream, and means for recirculating the hydrocarbon product stream to the process gas. The hydrogen separator may comprise any suitable separator, for example an electrochemical separator configured to capture hydrogen from the hydrogen-containing output gas. The hydrocarbon product stream may be recirculated to any suitable stage of the process. For example, the hydrocarbon product stream may be recirculated and blended into the feed stream to the apparatus, or may be provided to the regulator system for blending into the process gas, or may be blended into the process gas upstream of the plasma nozzle. Where the hydrocarbon product stream is at a lower pressure than a stream with which it is blended, for example a high pressure feed stream, the apparatus may comprise a compressor for pressurising the hydrocarbon product stream to a higher pressure than the stream into which it is recirculated. The compressor may be controllable based on one or more pressure sensors configured to monitor the pressure of the hydrocarbon product stream and a stream into which it is recirculated.

As will be appreciated, depending on the size of the container in which the apparatus is housed, a hydrogen separator and means for recirculating the hydrocarbon product stream may in some embodiments be external to the apparatus, for example provided by a separate hydrogen separation module, that may comprise a separate containerised apparatus. In other embodiments, a hydrogen separator and recirculation of the hydrocarbon product stream may be provided as part of the same containerised apparatus as the plasma reactor system.

The apparatus may additionally comprise a generator configured to provide electrical power to the apparatus using the feed stream comprising hydrocarbons and/or the hydrogen-containing output gas, for example the generator may comprises a gas combustion generator and/or a hydrogen fuel cell. In this way, the apparatus may be self-powered using a part of the feed stream or at least a part of the product gas from the apparatus. Where the apparatus is powered by a hydrogen fuel cell or combustion of hydrogen, it will be appreciated that the apparatus may be used to convert a polluting hydrocarbon gas stream into carbon free emissions and graphene. In this way, a hydrocarbon feed stream that may otherwise have been wasted by release or flaring can be converted to clean emissions such as water vapour and valuable graphene-containing solid carbon products. As will be appreciated, depending on the size of the container in which the apparatus is housed, a generator as described herein may in some embodiments be external to the apparatus, for example provided by a separate power module, that may comprise a separate containerised apparatus. In other embodiments, the generator may be provided as part of the same containerised apparatus as the plasma reactor system.

As described previously, the plasma reactor system may comprise a reaction chamber, a plasma nozzle coupled to the reaction chamber, and means for supplying the process gas to the plasma nozzle. As will be appreciated, the plasma reactor system may comprise one or more plasma nozzles coupled to the reaction chamber, for example the plasma reactor system may in some embodiments comprise a plurality of plasma nozzles coupled to the reaction chamber. Suitably, plasma nozzles coupled to a reaction chamber that may be used to produce graphene and hydrogen are described in WO 2015/189643 A1 and WO 2012/147054 A1. The plasma reactor system may comprise means for providing radio frequency radiation to the process gas within the plasma nozzle so as to produce a plasma within the plasma nozzle, and thereby cause cracking of hydrocarbons in the process gas within the plasma nozzle to provide cracked hydrocarbon species, wherein the plasma nozzle is arranged such that an afterglow of the plasma extends into the reaction chamber, the cracked hydrocarbon species also pass into the reaction chamber and recombine within the afterglow to provide graphene and hydrogen in the reaction chamber.

The plasma nozzle is preferably shaped and configured so as to cause at least one vortex to be formed in the process gas within the plasma nozzle, said vortex being subjected to said radio frequency radiation. Preferably, the plasma nozzle is shaped and configured so as to cause multiple vortices to be formed in the process gas within the plasma nozzle, said multiple vortices being subjected to said radio frequency radiation. The use of multiple vortices in this manner increases the time for which the process gas is exposed to the radiation, thereby increasing the efficiency of the plasma cracking process. It can also allow better plasma stability by generating an area of lower pressure inside a third vortex where the plasma is more confined. Thus, in a preferred embodiment, three vortices are formed within the plasma nozzle. The multiple vortices may suitably be concentric vortices.

Preferably, the plasma is generated at substantially atmospheric pressure. For example, the process gas may be provided to the plasma nozzle at atmospheric pressure or at a slight positive pressure, such as a pressure from about 1 to 1.5 bar absolute. It will nonetheless be appreciated that the process gas may be provided to the plasma nozzle at pressures higher than atmospheric pressure, for example up to about 3 bar absolute or up to about 10 bar absolute. For the sake of completeness, we note here that some parts of the plasma may not be at atmospheric pressure when it is formed at the core of a vortex where its pressure is likely to be lower than atmospheric pressure. However, there may suitably be no further system used to change the pressure of the plasma in the nozzle other than the fluid mechanics induced by the nozzle design.

The plasma nozzle may comprise: one or more inlets to receive a stream of the process gas, that forms a first vortex in use; an open end in communication with the reaction chamber; and a vortex-reflecting end opposite the open end; wherein the nozzle is internally tapered towards the open end; such that, in use, a second vortex is created by the vortex-reflecting end, and a third vortex is produced by reflection of the second vortex from the vortex-reflecting end. Advantageously, the second vortex is created by the vortex-reflecting end which “sucks” the first vortex (by virtue of the Coanda effect) and then reflects it to form the third vortex.

It will be appreciated that an open end of the plasma nozzle in communication with the reaction chamber will have a cross-section that is smaller than the dimensions of the reaction chamber, for example such that the nozzle provides an opening through a wall of the reaction chamber. Preferably, the exit of one or more plasma nozzles coupled to the reaction chamber (which may include means for actively cooling the afterglow) is flush with the wall of the chamber, so as to provide a flat surface that may for example be cleaned by a scraper system as described elsewhere herein.

The plasma nozzle may be coupled to the reaction chamber so as to direct flow from the plasma nozzle towards the centre of the reaction chamber, for example wherein the plasma nozzle provides a flow (and afterglow) radially inwards into the reaction chamber. In other embodiments, the plasma nozzle may be disposed at least partially at an angle from the perpendicular to the wall of the reaction chamber to which it is coupled. For example, the plasma nozzle is disposed so as to provide a flow into the reaction chamber at an angle of less than 90 degrees from the wall of the reaction chamber (e.g. a tangent to the wall at the point at which the plasma nozzle is disposed).

The means for supplying radio frequency radiation may comprise a microwave generator (for example operating at 2.45 GHZ, although other frequencies are also usable). A waveguide may be arranged to direct the radio frequency, for example microwave, radiation to the nozzle, for example to coincide with the vortex(es) of the process gas. As those skilled in the art will appreciate, the expression “radio frequency radiation” encompasses the full extent of microwave frequencies, together with a range of non-microwave frequencies. In some embodiments, the radio frequency radiation is terahertz radiation, for example radio frequency radiation in the range of from 0.3 THz to 3 THz. The radio frequency radiation may be suitably provided at various power levels according to the requirements of a particular system. As a general rule, higher power of the plasma system gives better cracking efficiency and allows processing of higher process gas flow rates. Scaling and increasing the power of the plasma system may be achieved by combining several nozzles around a reaction chamber or by increasing the power of the microwave generator and providing a larger nozzle. The power of the microwave generator may be between 1 and 30 KW, for example between 1 and 20 KW. However, there is no restriction of scale on the nozzle and so the power may be varied accordingly. For example, in some embodiments the power may be up to 100 KW or up to 1 MW. Process gas flow through the plasma nozzle may for example be in the range of about 20 L/min to 150 L/min depending on the precise scale of the nozzle, however it will be appreciated that the flow rate may suitably be varied according to a particular nozzle and reactor setup and desired conversion efficiency of hydrocarbons in the process gas. For example, when the power provided for producing plasma in the plasma nozzle is increased then the flow rate may also be increased whilst maintaining the conversion efficiency of the process gas. The pressure at which the process gas is provided to the plasma nozzle will suitably depend on the desired pressure in the reaction chamber, and may suitably for example be higher than the reaction chamber pressure, for example about 0.1 bar to 0.5 bar higher than the pressure in the reaction chamber, such as 0.2 to 0.4 bar higher than the pressure in the reaction chamber.

As described, the plasma reactor system may in some embodiments comprise a plurality of plasma nozzles coupled to the reaction chamber. A plurality of plasma nozzles may be distributed in any suitable way around the reaction chamber and in preferred embodiments the plasma nozzles are distributed so as to minimise interference between the respective afterglow exiting each plasma nozzle, for example the plasma nozzles may be distributed evenly around the periphery of the reaction chamber, for example circumferentially around the reaction chamber (e.g. 180 degrees apart for 2 nozzles, 120 degrees apart for 3 nozzles, 90 degrees apart for 4 nozzles and so on). The plasma nozzles may be distributed vertically within the reaction chamber, for example plasma nozzles may be separated vertically on the walls of the reaction chamber (for example separated by at least about 5 cm, such as at least about 8 cm or at least about 10 cm), and may also be distributed around the periphery of the chamber as previously described (e.g. circumferentially) or may be disposed vertically above or below another plasma nozzle. The number of plasma nozzles coupled to the reaction chamber may be selected based on the reaction chamber volume, so as to limit the temperature within the reaction chamber to avoid degradation of graphene in the reaction chamber (for example to limit the temperature of gases in the reaction chamber to no more than about 200° C.). Each plasma nozzle may be orientated radially towards the centre of the reaction chamber or may be disposed at an angle to the wall of the reaction chamber as described previously.

Due to the increase in volume when passing from the plasma nozzle into the reaction chamber, the afterglow from the plasma and the cracked species present in the afterglow may be passively cooled upon entering the reaction chamber. In some preferred embodiments, the reaction chamber incorporates means for actively cooling the afterglow on exiting the plasma nozzle, such as direct cooling by introducing a flow of gas (at a lower temperature than the afterglow) to mix with species in the afterglow, or indirect cooling by a heat exchanger carrying a refrigerant or a heat pipe system configured to draw heat away from the afterglow exiting the plasma nozzle.

Preferably, in use, the afterglow within the reaction chamber has an operating temperature lower than 3500° C. More preferably, in use, the afterglow within the reaction chamber has an operating temperature lower than 1000° C. For instance, the operating temperature of the afterglow within the reaction chamber can be as low as 300° C. Preferably, in use, the temperature just outside the nozzle, at the carbon formation point within the afterglow, is in the range of 800° C. to 1200° C. Particularly preferably this temperature is in the range of 900° C. to 1000° C. Nonetheless, it will be appreciated that the gas temperature in the reaction chamber will be significantly lower than this outside of the afterglow.

The plasma generated in the nozzle is preferably a non-equilibrium plasma (also referred to as a non-thermal plasma) such as is known in the art, for example a plasma in which the electron temperature is greater than the temperature of heavier species (ions and neutral species) in the plasma.

In some embodiments, the process gas may comprise a buffer gas, such as argon, nitrogen or helium, that is blended with the feed stream to provide the process gas. For example, the apparatus, e.g. the regulator system, may be configured to blend a buffer gas with a hydrocarbon feed to form the process gas. It will be appreciated in this context that a buffer gas refers to an inert gas, such as argon or nitrogen, added to dilute the hydrocarbons in the process gas and not to inert gases present in the feed stream itself that is provided to the apparatus (for example small amounts of nitrogen, argon and so on that may be present in natural gas) or to blending of hydrocarbon gases with the feed stream. If a buffer gas is used, the ratio of hydrocarbon species to buffer gas in the process gas is preferably 50:50 or less, for example around 20:80 or less. Preferably, no buffer gas is provided in the process gas. It will nonetheless be appreciated that the apparatus may be configured to blend hydrocarbon gases to provide the process gas. For example, the apparatus may be configured to store hydrocarbon gases from the feed stream, which may be blended with gases from the feed stream subsequently, and/or the apparatus may be configured to recirculate hydrocarbon gases in the hydrogen-containing output gas as described elsewhere herein.

As described, the apparatus comprises a hydrogen outlet for removing hydrogen from the containerised apparatus and/or hydrogen storage means within the containerised apparatus. In some embodiments, the apparatus may comprise both a hydrogen outlet for removing hydrogen from the containerised apparatus and hydrogen storage means within the containerised apparatus so that hydrogen-containing gas in the hydrogen storage means can leave the apparatus via the hydrogen outlet. Alternatively, or additionally, the apparatus may be operable to control passage of the hydrogen-containing output gas from the plasma reactor system to either the hydrogen storage means or the hydrogen outlet, or to control a ratio of the hydrogen-containing output gas that is provided to storage vs that provided to the outlet.

Similarly, the apparatus comprises a graphene outlet for removing graphene-containing solids from the containerised apparatus and/or graphene storage means within the containerised apparatus and the apparatus may in some preferred embodiments comprise both. For example, the apparatus may comprise graphene storage means for receiving graphene-containing solids from the plasma reactor system, for example via a hopper and extraction system as described herein, and means for providing the graphene-containing solids in the storage means to a graphene outlet. Alternatively, or additionally, the apparatus may be operable to control passage of the graphene-containing solids from the plasma reactor system to either the graphene storage means or the graphene outlet, or to control a ratio of the graphene-containing solids that is provided to storage vs that provided to the outlet.

In some embodiments the graphene outlet may comprise the hydrogen outlet or vice versa. For example, the apparatus may be configured such that the graphene containing solids are conveyed from the containerised apparatus by a carrier gas comprising at least a portion of the hydrogen containing output gas.

For example, in some embodiments, the apparatus may not comprise a hopper and a filter as described herein and the apparatus may be configured to provide a suspension of graphene containing solids carried by the hydrogen-containing output gas from the plasma reactor system directly to a combined graphene and hydrogen outlet. Alternatively, the apparatus may separate the hydrogen-containing output gas from the graphene containing solids as described herein (and optionally to store the hydrogen-containing gas or the graphene-containing solids), and then recombine the hydrogen-containing output gas with the graphene-containing solids to convey the graphene-containing solids from the apparatus with a carrier gas comprising at least a portion of the hydrogen-containing output gas.

The apparatus may be configured to operate under automated and/or remote control. Therefore, in preferred embodiments the apparatus comprises a controller configured to control operation of the apparatus.

Preferably in response to an activation signal, the controller is configured to control the apparatus to provide the process gas to the plasma nozzle, and to provide the radio frequency radiation to the process gas within the plasma nozzle so as to produce a plasma within the nozzle. Thus, the controller can be configured to initiate operation of the plasma reactor system for producing hydrogen and graphene from a hydrocarbon feed stream.

The apparatus may comprise a plurality of sensors configured to provide information to the controller in relation to the conditions within the apparatus, such as temperature measurements, pressure measurements, gas composition measurements such as quantities of particular species (for example an oxygen sensor), status indications from parts of the apparatus such as indications of the open or closed status of valves or flow passages, whether the plasma nozzle is operational or not and so on. Sensors may also provide an indication to the controller of external connections to the apparatus, such as whether the apparatus is connected to an external module, such as a module for receiving graphene or hydrogen from the apparatus, a module providing power to the apparatus, a module processing or analysing products from the apparatus such as a hydrogen/hydrocarbon gas separation module or a quality control module for indicating the quality of graphene that is produced by the apparatus and so on.

In preferred embodiments, the controller is configured to receive information from the plurality of sensors of the apparatus and to control operation of the apparatus based on information received from the plurality of sensors.

Preferably, the controller is configured to receive an indication of the pressure of the feed stream, such as from a feed pressure sensor, and to control the regulator system to regulate the pressure of the feed stream to provide the process gas at a selected pressure, for example at substantially atmospheric pressure.

The controller can control various elements of the apparatus to control its operation fully autonomously. For example, in preferred embodiments, the controller is configured, in response to an indication to empty the hopper, to close the separation valve to isolate the reaction chamber from the hopper (and thereby cause graphene-containing solids to accumulate on a surface of the valve) and to operate means for extracting graphene-containing solids from the hopper to the graphene storage means or the graphene outlet, for example to operate a cyclonic separator and a vacuum source as described herein. Preferably, following extraction of graphene-containing solids from the hopper, the controller is configured to close an exhaust valve to isolate the hopper from the means for extracting graphene-containing solids from the hopper, and to open the separation valve to permit graphene-containing solids to enter the hopper from the reaction chamber. Thus, the plasma reactor system may be configured to continuously produce graphene and hydrogen during emptying of the hopper.

The indication to empty the hopper may be provided by a sensor configured to provide the indication to empty the hopper when the amount of graphene-containing solids present in the hopper exceeds a predetermined threshold, for example a proximity sensor. The indication to empty the hopper may alternatively, or additionally, be provided at predetermined time intervals during continuous operation of the plasma reactor system.

The controller may be configured to operate the apparatus to ensure safe operation of the apparatus in an autonomous manner. For example, the controller is preferably configured to purge hydrogen-containing gas from the hopper after isolating the hopper from the reaction chamber and prior to emptying the hopper of solids and/or the controller is configured to purge the hopper with inert gas prior to re-opening the hopper to the reaction chamber. In this way, the graphene-containing solids can be removed from the plasma reactor system during continuous operation, without exposing flammable or explosive gases to oxygen in the plasma reactor system.

The reaction chamber and/or the hopper preferably comprises an oxygen sensor, and the controller is configured to open the separation valve between the reaction chamber and the hopper only in the event that the oxygen level is below a predefined threshold. Preferably, the hopper comprises a pressure sensor and the controller is configured to pressurise the hopper, for example with inert gas, and to open the separation valve only in the event that a pressure drop in the hopper over a set period of time is below a predefined threshold. In this way, the hopper can be tested for leaks prior to opening the hopper to the reaction chamber. It will be appreciated that the pressure in the hopper can be suitably reduced after pressure testing prior to opening the separation valve to the reaction chamber.

The apparatus/controller is preferably configured to provide a start-up procedure for safe operation of the plasma reactor system. Preferably, the reaction chamber comprises an oxygen sensor, and the controller is configured to control the plasma reactor system to produce a plasma within the plasma nozzle only in the event that the oxygen level is below a predefined threshold. In preferred embodiments, the controller is configured to purge the reaction chamber with an inert gas or the process gas prior to controlling the reactor system to produce a plasma within the plasma nozzle. The controller can also be configured to control the apparatus to pressurise the reaction chamber (and optionally the hopper) with gas such as inert gas to perform a leak test (monitoring for a pressure drop over a predefined time period) and to control the plasma reactor system to produce a plasma within the plasma nozzle only in the event that no leak is detected. A leak test may be performed on the reaction chamber with the separation valve closed, followed by a leak test of the reaction chamber and hopper (i.e. with the separation valve open) so as to determine if a leak is from the reaction chamber or the hopper. Pressure testing may be performed suitably at any pressure, such as above normal operating pressure of the reaction chamber (for example about 0.5 bar above reaction chamber operating pressure).

The controller may be configured to stop operation of the plasma reactor system, for example to stop providing power to the plasma nozzle and to stop flow of process gas into the plasma nozzle in response to an indication to stop operation, for example an emergency stop indication. An indication to stop may be provided automatically by the controller in response to information received from sensors or may be manual, for example in response to a remote control signal or a local control signal, for example from an emergency stop button or other switch of the apparatus.

The controller is preferably configured to operate a scraper system, such as a scraper system as defined elsewhere herein, to remove material that is deposited on an internal wall of the reaction chamber. For example, the controller is preferably configured to operate the scraper system in response to an indication to remove deposited material or at predetermined time intervals during continuous operation of the plasma reactor system. The controller may be configured to control the position of a scraper arm of the scraper system within the reaction chamber, for example wherein the controller can receive an indication of the position of the scraper arm and to control the scraper system to move the scraper arm to move across the whole of the internal walls with which it can contact, for example to complete a full rotation around the perimeter of the reaction chamber.

In some preferred embodiments, the controller is configured to control heating one or more internal walls of the reaction chamber to reduce or avoid precipitation of vapours that are present in the reaction chamber on the one or more internal walls of the reaction chamber, for example as described previously herein.

The plasma reactor system preferably comprises one or more pressure sensors, and in response to the activation signal the controller is configured to pressurise the plasma reactor system and to control the plasma reactor system to produce graphene and hydrogen only in the event that a pressure drop in the system, for example a pressure drop in the reaction chamber, over a set period of time is below a predefined threshold. In this way, the controller can control the apparatus to ensure that leaks are not present prior to operating the plasma reactor system.

The controller may be configured to control means for recirculating hydrocarbons in the hydrogen-containing output gas to control the proportion of hydrocarbons in the hydrogen-containing output gas that are recirculated to the plasma reactor system as described herein. For example, the controller may receive or store an indication of a desired proportion of hydrogen or hydrocarbon gas provided by the apparatus, and control recirculation of hydrocarbon gas from the plasma reactor system in order to achieve a desired proportion of hydrogen or hydrocarbon gas provided by the apparatus. For example, the controller may receive an indication of the pressure of a separated hydrogen product stream and hydrocarbon product stream separated in a hydrogen separator, and to control operation of the hydrogen separator and/or the plasma reactor system and/or recirculation of the hydrocarbon gas, based on the pressure indications, for example the relative pressure of the hydrogen product stream and hydrocarbon product stream from the hydrogen separator. The controller may also control a compressor as described previously herein based on one or more pressure sensors configured to monitor the pressure of the hydrocarbon product stream and a stream into which it is recirculated, so as to provide the hydrocarbon product stream at a pressure higher than the stream into which it is recirculated to enable blending.

The apparatus is preferably configured for remote control, for example by a user in a location remote from the apparatus. Preferably, the apparatus comprises a communications interface configured to provide network access to the controller, for example wherein the controller is configured to use the communications interface to provide remote access to analytical information such as sensor data and/or to receive control signals remotely via the network. The network may comprise the internet, or may comprise a LAN network or any other suitable network as will be appreciated by one of skill in the art. The communications interface may comprise a router configured to provide internet access to the controller, and may be suitable to provide VPN access such as to provide remote access to the controller via a secure VPN.

The controller may preferably comprise a user interface, such as a human machine interface, to provide monitoring and control of the apparatus to a user present at the apparatus. It will be appreciated that information and control provided at a user interface may alternatively or additionally be provided externally to a remote user via the communications interface.

The controller may be configured to use any suitable communications technology to monitor and control the apparatus. For example, the controller may comprise a server, such as a Scada server, which may be configured to communicate with and control one or more additional control modules such as programmable logic controllers. The controller may be configured to monitor and control the apparatus/other control modules of the apparatus using any suitable technology as is known in the art of such control systems. For example, the controller may manage communications according to the Profinet protocol, for example using ethernet connections or the like. The controller and/or the apparatus may also comprise a memory configured to store information relating to operation of the apparatus in a database (for example an SQL-based database), which may be stored locally in the apparatus and/or remotely. In this way, a user can access historical operation data for the apparatus for analysis or diagnostics. Operation data may comprise time stamped records of control signals provided by the controller to the apparatus, and sensor data from the apparatus, for example pressure sensor data, temperature sensor data, gas sensor data, and power provided to the plasma nozzle, for example power to the microwave generator.

It will be appreciated that the controller as described herein may suitably be provided by any appropriate control logic, such as analogue control circuitry and/or digital processors, examples include field programmable gate arrays, FPGA, application specific integrated circuits, ASIC, a digital signal processor, DSP, or by software loaded into a programmable processor, or any combination thereof. Aspects of the disclosure comprise computer program products, which may be recorded on non-transitory computer readable media, and these may be operable to program a processor to perform any one or more of the methods described herein, for example to program a controller of an apparatus as described herein to perform any of the methods or control procedures described herein.

The apparatus may be configured to monitor the graphene produced by the plasma reactor system, and to control operation of the plasma reactor system based on the monitored quality of the graphene. Preferably, the apparatus comprises a Raman spectrometer configured to analyse the graphene-containing solids to provide an indication of the quality of the graphene. The Raman spectrometer may be any suitable spectrometer and may for example be a spectrometer using a 532 nm excitation laser at 0.2 mW power. The Raman spectrometer may suitably be arranged to analyse a flow of the graphene-containing solids, for example as it passes through an orifice or conduit, or to analyse a static sample of the graphene-containing solids, for example graphene-containing solids deposited on a window (for example a borosilicate glass window) through which the Raman spectrometer can perform analysis (for example a window into the hopper, the graphene storage means, a passage between the hopper and the graphene storage means and so on) or graphene-containing solids in the graphene storage means or a hopper as described herein.

Quality of graphene may suitably be determined according to analysis of peaks in the Raman spectrum, specifically the D peak (around 1320 cm⁻¹), the G peak (around 1570 cm⁻¹) and the 2D peak (around 2630 cm⁻¹). As will be appreciated, the D peak indicates sp3 hybridised carbon, which could be amorphous impurities in the sample but according to TEM may also stem mainly from the edges of graphitic flakes and is enhanced with increasing number of edges analysed in the sample, e.g. by smaller flake size. In this way, an increase in D/G ratio can provide an indication of smaller flake sizes and higher defect density. The G/2D ratio is significant for layer determination. The G peak intensity increases with the number of layers, while the 2D peak shows the highest intensity for single layer graphene. By analysis of graphene samples, such as by TEM and/or other techniques, to confirm graphene quality, corresponding parameters for peak intensity and ratios in Raman spectra can be set to provide an indication of graphene quality. The ISO/TS 21356-1:2021 standard describes tests that can be carried out to analyse graphene containing solids.

In preferred embodiments, the controller can be configured to control operation parameters of the plasma reactor system based on the Raman analysis of the graphene-containing solids, for example based on a quality rating of the graphene, which as discussed can be based on peak intensity ratios, peak width and/or peak position data in the Raman spectrum.

Preferably, the controller is configured to send an alert to an operator, to shut down the plasma reactor system, and/or to trigger an automated optimisation process in response to an indication that the graphene quality is below a predefined threshold.

An automated optimisation process may comprise modifying one or more process parameters whilst monitoring Raman analysis of the graphene-containing solids to determine a change to graphene quality, for example wherein the one or more process parameters comprises one or more of: gas flow rates into and out from the reaction chamber, reaction chamber and/or process gas pressure, power of the radio frequency radiation, frequency of removing material deposited on the internal reaction chamber walls or heating of reaction chamber walls. The plasma reactor system comprising a plasma nozzle as described herein is advantageously well-suited to such an optimisation process because it is robust to significant parameter changes during operation. The graphene quality following a change can then be monitored to indicate whether the change has improved graphene quality. In some embodiments, the controller is configured to perform the automated optimisation process in response to an indication that the graphene quality is below a predefined threshold, and in the event that the automated optimisation process does not improve the graphene quality, to send an alert to an operator and/or to shut down the plasma reactor system.

In preferred embodiments, the apparatus is configured to store a record of the operational parameters and graphene analysis from an optimisation process. In the event that graphene quality is increased by the optimisation process, the controller is preferably configured to store the optimised process parameters, for example to store a set of optimised process parameters and associate the set of optimised process parameters with a set of other conditions or parameters operated under during the optimisation process, such as process gas composition, temperature measurements in the plasma reactor system, gas concentrations (e.g. methane, hydrogen, oxygen, argon) in the container, or frequency of graphene collection from the hopper. In this way, the controller may be configured to apply corresponding optimised parameters during future operation where other operational parameters or conditions of the system also correspond to the stored optimised parameters. The controller may be configured to learn, for example by a machine learning process, how to optimise the process parameters to improve graphene quality based on an initial set of operation parameters and conditions the apparatus is operating under.

A further aspect provides a plasma reactor system for a portable containerised apparatus configured to produce hydrogen and graphene from a process gas comprising hydrocarbons, the plasma reactor system comprising a reaction chamber and a gas outlet configured to receive a hydrogen-containing output gas from the reaction chamber, and a planar filter element arranged to separate the reaction chamber from the gas outlet, wherein the planar filter element is configured to prevent graphene-containing solids from entering the gas outlet.

As will be appreciated the plasma reactor system and/or the planar filter element and/or the portable containerised apparatus of this aspect may be substantially as defined elsewhere herein.

Preferably, the plasma reactor system has a height of less than 2.9 m, preferably less than 2.5 m, for example less than 2.0 m. For example, preferably the reaction chamber and planar filter element have a combined height of less than 2 m, for example less than 1.5 m.

A further aspect provides a plasma reactor system for a portable containerised apparatus configured to produce hydrogen and graphene from a process gas comprising hydrocarbons, the plasma reactor system comprising a reaction chamber and a graphene removal port below the reaction chamber, and a hopper configured to receive graphene-containing solids from the reaction chamber through the graphene removal port, wherein the graphene removal port comprises a separation valve operable to isolate the reaction chamber from the hopper.

As will be appreciated the plasma reactor system and/or the portable containerised apparatus of this aspect may be substantially as defined elsewhere herein. For example, the plasma reactor system may comprise means for extracting graphene-containing solids from the hopper to a graphene storage means, for example a cyclonic separator and a vacuum source as defined elsewhere herein, and/or wherein the hopper comprises one or more gas inlets for receiving a flow of air and/or inert gas.

A further aspect provides a plasma reactor system for a portable containerised apparatus configured to produce hydrogen and graphene from a process gas comprising hydrocarbons, the plasma reactor system comprising a reaction chamber and a scraper system for removing material that is deposited on the interior of one or more walls of the reaction chamber and/or means for heating one or more internal walls of the reaction chamber to reduce or avoid precipitation of vapours in the reaction chamber on the one or more internal walls of the reaction chamber.

As will be appreciated the plasma reactor system and/or the portable containerised apparatus of this aspect may be substantially as defined elsewhere herein. For example, the scraper system preferably comprises a motor operable to move, for example to rotate, a scraper arm of the scraper system to move the scraper arm around the internal surface of one or more walls of the reaction chamber.

A further aspect provides a plasma reactor system for a portable containerised apparatus configured to produce hydrogen and graphene from a process gas comprising hydrocarbons, the plasma reactor system comprising a Raman spectrometer configured to analyse graphene-containing solids produced by the plasma reactor system; and a controller configured to control operation parameters of the plasma reactor system based on the Raman analysis of the graphene-containing solids.

As will be appreciated the plasma reactor system and/or the portable containerised apparatus of this aspect may be substantially as defined elsewhere herein. For example, the controller may be configured to control operation parameters of the plasma reactor system as described elsewhere herein, for example to perform an automated optimisation process.

A further aspect provides a method of operating a portable containerised apparatus for producing hydrogen and graphene, comprising: providing a process gas comprising hydrocarbons to a plasma reactor system within the containerised apparatus, the plasma reactor system configured to produce hydrogen and graphene from the process gas; providing a hydrogen-containing output gas from the plasma reactor system to a hydrogen outlet for removing hydrogen from the containerised apparatus and/or to hydrogen storage means within the containerised apparatus; and providing graphene-containing solids from the plasma reactor system to a graphene outlet for removing graphene from the containerised apparatus and/or to graphene storage means within the containerised apparatus.

As will be appreciated the portable containerised apparatus and any elements of the portable containerised apparatus may be substantially as described elsewhere herein. For example, the method may comprise operating the apparatus according to the configuration of the controller as described herein.

Preferably, the method comprises regulating the pressure of a feed stream comprising hydrocarbons to provide the process gas comprising the hydrocarbons at a selected pressure, for example at substantially atmospheric pressure. As discussed previously, the pressure may nonetheless be varied depending on the requirements of the system. Preferably, the process gas is provided to the plasma reactor system (e.g. to one or more plasma nozzles) at a pressure higher than the reaction chamber pressure, for example about 0.1 bar to 0.5 bar higher than the pressure in the reaction chamber, such as 0.2 to 0.4 bar higher than the pressure in the reaction chamber.

The process gas is preferably provided to the plasma reactor system in response to receiving an activation signal to operate the apparatus for producing hydrogen and graphene. For example, an activation signal provided by a user.

The flow rate of process gas into the chamber (e.g. through one or more plasma nozzles), may be controlled, together with the gas flow rate out from the reaction chamber (e.g. through the gas outlet) in order to control the pressure within the reaction chamber. Suitably, the pressure in the reaction chamber may be about atmospheric pressure, preferably at a positive pressure relative to atmospheric pressure, such as at least about 0.1 bar above atmospheric pressure. In some embodiments, the pressure in the reaction chamber may be higher, such as up to about 3 bar or up to about 10 bar, such as up to about 20 bar.

In preferred embodiments, the method comprises separating the graphene and hydrogen within in the containerised apparatus to provide the hydrogen-containing output gas and graphene-containing solids. For example, wherein the hydrogen-containing output gas and graphene-containing solids are separated within the reaction chamber by a filter such as a planar filter as described herein.

The hydrogen-containing output gas and the graphene-containing solids may leave the containerised apparatus by a common outlet, for example wherein the graphene-containing solids are conveyed from the containerised apparatus by a carrier gas comprising at least a portion of the hydrogen-containing output gas, the graphene containing solids and hydrogen-containing output gas optionally being separated at a location remote from the containerised apparatus. The hydrogen-containing output gas and the graphene-containing solids may be separated within the apparatus, or externally from the apparatus, prior to recombining at least a portion of the hydrogen-containing output gas and the graphene-containing solids to convey the graphene-containing solids using the hydrogen-containing output gas, for example wherein the hydrogen-containing output gas is pressurised and/or pumped to a higher flow rate for conveying the graphene-containing solids. In embodiments, the apparatus may comprise one or more compressors and/or pumps configured to provide a flow of gas, which may comprise at least a portion of the hydrogen-containing output gas, for conveying the graphene-containing solids out from the apparatus.

In preferred embodiments, the graphene containing solids are provided to a hopper coupled to a reaction chamber of the plasma reactor system in which the graphene containing solids are present, wherein the method comprises extracting graphene-containing solids from the hopper to graphene storage means or to a graphene outlet from the containerised apparatus by isolating the hopper from the reaction chamber and extracting the graphene-containing solids from the hopper whilst continuing to produce graphene and hydrogen in the reaction chamber.

Extraction of graphene-containing solids from the hopper may be performed in response to an indication to empty the hopper, for example an indication from a sensor that the hopper is full, or at predetermined time intervals during continuous production of graphene and hydrogen in the plasma reactor system.

The hydrogen-containing output gas may preferably be separated, such as by electrochemical separation, to provide a hydrogen product stream and a hydrocarbon product stream. Separation may be performed within the portable containerised apparatus or externally, for example in a separate hydrogen separation module comprising a hydrogen separator such as an electrochemical separator.

It will be appreciated that the hydrocarbon product stream separated from the hydrogen-containing output gas will have an increased concentration of hydrocarbon gas and a lower concentration of hydrogen gas relative to the hydrogen-containing output gas, and that the hydrogen product stream will have an increased concentration of hydrogen gas and a lower concentration of hydrocarbon gas relative to the hydrogen-containing output gas. In embodiments, a hydrogen product stream and a hydrocarbon product stream separated from the hydrogen-containing output gas may consist essentially of hydrogen or hydrocarbon gas, respectively. The proportion of hydrocarbons remaining in the separated hydrogen product stream and/or the proportion of hydrogen remaining in the hydrocarbon product stream may suitably be a result of the efficiency of the separation process, or in some embodiments the separation may be controlled to provide a hydrogen or hydrocarbon product stream having a particular composition. The hydrogen or hydrocarbon product streams may also comprise other gases that are present in the process gas or are introduced or produced within the apparatus, such as inert gases including nitrogen, argon and the like, or CO₂.

In preferred embodiments, at least a portion of the hydrocarbon product stream is recirculated to provide at least a portion of the process gas, and/or at least a portion of the hydrocarbon product stream is provided to a second portable containerised apparatus comprising a plasma reactor system for producing hydrogen and graphene. In this way, hydrocarbons in the feed gas may be converted completely into hydrogen and graphene-containing solids, avoiding emission of hydrocarbon gases or CO₂ into the atmosphere.

The method may comprise providing electrical power to the apparatus using at least a portion of the hydrogen-containing output gas and/or a hydrocarbon gas used to supply hydrocarbons to the apparatus. For example, power may be generated and provided to the apparatus using a gas combustion generator and/or a hydrogen fuel cell.

Preferably, the process gas is provided at least in part by a feed stream comprising hydrocarbons, wherein the feed stream comprising hydrocarbons is drawn from a hydrocarbon gas source such as a natural gas supply or pipeline.

In some preferred embodiments, the feed stream comprising hydrocarbons is drawn from a hydrocarbon gas supply flow. Preferably, the hydrogen-containing output gas, and/or a hydrogen product stream separated from the hydrogen-containing output gas, is blended with the hydrocarbon gas supply flow to provide a reduced-carbon gas blend; or the hydrocarbon gas supply flow is replaced by the hydrogen-containing output gas and/or a hydrogen product stream separated from the hydrogen-containing output gas. In a preferred embodiment the method comprises sensing the pressure of one or more gas flows selected from: the feed stream comprising hydrocarbons, the hydrocarbon gas supply flow, the hydrogen-containing output gas, the hydrocarbon product stream, or the hydrogen product stream, and controlling one or more of the gas flows to provide or maintain a desired composition of at least one the gas flows. For example, pressure of the hydrocarbon gas supply flow and the hydrogen product stream may be monitored to determine the composition of a reduced-carbon gas blend resulting from the blending of these streams. In order to maintain a composition of the reduced-carbon gas blend, the pressure of the hydrogen product stream may be varied, for example at the hydrogen separator, to maintain a desired composition of the reduced-carbon gas blend. In general, the hydrogen content of the reduced-carbon gas blend may vary according to the requirements of an end user. In some preferred embodiments, the reduced-carbon gas blend may comprise no more than about 20 mol. % of hydrogen, for example no more than about 15 mol. % of hydrogen, such as about 10 mol. % or less hydrogen.

In a preferred embodiment, the method may comprise recirculating the hydrocarbon product stream to provide a portion of the process gas to the plasma reactor system, for example blending the hydrocarbon product stream with the feed stream, and producing electrical power using the hydrogen product stream, for example using a gas combustion generator and/or a hydrogen fuel cell. The generated electricity may be used to power the containerised apparatus itself and/or may be used to provide electrical power to a power network or to any other external system. In this way, by only using a hydrocarbon supply, such as a natural gas or methane feed, the containerised apparatus can produce an electricity supply on demand from the hydrocarbons, whilst also at least partially powering itself and avoiding carbon emissions.

A preferred embodiment comprises operating a plurality of portable containerised apparatuses for producing hydrogen and graphene, wherein the plurality of containerised apparatuses receive hydrocarbons for the process gas from a common hydrocarbon source, and wherein the hydrogen-containing output gas from each of the plurality of containerised apparatuses is combined to provide a common hydrogen output gas flow and/or the graphene-containing solids from each of the plurality of containerised apparatuses is provided to a common graphene storage means. Thus, the throughput of hydrocarbons to hydrogen and graphene can be scaled as desired by connecting multiple containerised apparatuses in parallel.

In the present method, the process gas preferably comprises or consists essentially of methane, for example wherein the process gas comprises or consists essentially of natural gas.

A further aspect provides a modular system for producing hydrogen and graphene from a hydrocarbon source, the system comprising a plurality of modules each configured to cooperate with one or more of the other modules. The modules may preferably comprise a portable containerised module so that each module can be easily transported and operated in different locations and in different configurations with other modules in the system. For example, the plasma reactor module and at least one other module, or at least two other modules, or each of the plurality of modules may comprise a portable containerised module. Preferably, each module is contained within an intermodal container, such as a shipping container in accordance with ISO standard 668:2020. As will be appreciated, in some embodiments, multiple modules of the plurality of modules may be combined into a single container. Thus, where the plurality of modules are portable containerised modules, this may include each module present as separate portable containerised modules, or two or more modules combined in a single container.

The plurality of modules comprises:
a portable containerised plasma reactor module comprising a plasma reactor system configured to receive hydrocarbons from the hydrocarbon source and to provide a hydrogen-containing output gas and graphene-containing solids; and at least one of:
a power module configured to receive hydrocarbons from the hydrocarbon source and/or the hydrogen-containing output gas and to provide electrical power, for example to provide electrical power to one or more other modules of the plurality of modules;
a hydrogen separation module configured to receive the hydrogen-containing output gas and to separate hydrogen from hydrocarbons in the hydrogen-containing output gas;
a further plasma reactor module;
a module configured to receive the graphene-containing solids and a carrier gas, such as the hydrogen-containing output gas or a hydrocarbon-containing gas from the hydrocarbon source, and to convey the graphene-containing solids along a pipeline as a fluidised powder using the carrier gas;
a module configured to receive graphene-containing solids as a fluidised power in a carrier gas, and to separate the graphene from the carrier gas;
a graphene collection module comprising a vacuum source and a cyclonic separator configured to extract graphene-containing solids from at least one plasma reactor module in a carrier gas using the vacuum source, and to separate the graphene-containing solids from the carrier gas in the cyclonic separator to store the graphene-containing solids;
a control module comprising a controller configured to communicate electronically, for example via a network, with one or more other modules of the plurality of modules to control operation of the other modules and/or to provide remote network access to analytical information such as sensor data;
a quality control module configured to receive graphene-containing solids, and comprising a Raman spectrometer configured to analyse the graphene-containing solids to determine a quality of graphene that is present;
a hydrogen storage module configured to receive a hydrogen-containing output gas from one or more other modules and to store the hydrogen, such as by compression;
a graphene extraction module configured to extract graphene-containing solids from one or more plasma reactor modules, and to provide the graphene-containing solids to an external graphene storage means; and
a graphene storage module configured to receive and store graphene-containing solids from one or more other modules.

The modular system may comprise a plurality of containers that can be attached together, either for shipping or for operation, as is known in the art for intermodal containers, for example using attachment means between containers such as twist locks between containers. Such means may be used to stack and attach containers to each other at the point of use, for example by stacking plasma reactor modules in parallel for receiving a hydrocarbon containing feed stream from a common source.

As will be appreciated, the portable containerised plasma reactor module may be substantially as described previously herein in relation to the portable containerised apparatus.

A power module may suitably comprise any means of providing electrical power using hydrocarbons such as natural gas or hydrogen, or a mixture thereof. For example, the power module may comprise a combustion generator and/or a hydrogen fuel cell.

The hydrogen separation module may comprise any suitable means for separating hydrogen from hydrocarbon gases. For example, a hydrogen separation module may comprise a hydrogen-selective membrane separator, for example a pressure-driven or electrochemical membrane separator. Preferably, the hydrogen separator comprises an electrochemical separator. The hydrogen separation module suitably receives a hydrogen-containing gas, such as the hydrogen-containing output gas from a plasma reactor module, and provides a hydrogen product stream, which may consist essentially of hydrogen (it will be appreciated that the hydrogen separation process may leave some level of gas impurities in the hydrogen product stream) or may comprise a blend of hydrogen and other gases, such as hydrocarbon gases e.g. methane. As will be appreciated, the hydrogen product stream will be enriched in hydrogen compared to the hydrogen-containing gas that is provided to the hydrogen separation module.

A further plasma reactor module will suitably comprise a plasma reactor module comprising a plasma reactor system configured to receive hydrocarbons and to provide a hydrogen-containing output gas and graphene-containing solids. The further plasma reactor module may be configured to receive hydrocarbons from the hydrocarbon source or may be configured to receive a hydrocarbon feed stream from another source, for example a hydrocarbon product stream obtained from another plasma reactor module or from a hydrogen separation module in which hydrocarbons are separated from hydrogen and provided to the further plasma reactor module. It will also be appreciated that a further plasma reactor module may be as described previously herein in relation to the portable containerised apparatus, and may be the same as or different to other plasma reactor modules in the modular system.

The module configured to convey the graphene-containing solids along a pipeline as a fluidised powder using the carrier gas may suitably use any suitable equipment and carrier gas. For example, this module may comprise one or more compressors and/or pumps configured to provide a flow of carrier gas to convey the graphene-containing solids. The module may be configured to receive a carrier gas and graphene-containing solids separately, or in some embodiments the module may be configured to receive graphene-containing solids suspended in a gas, where the module may be configured to convey that gaseous suspension or to blend an additional carrier gas with the gaseous suspension. At a remote location, the fluidised powder conveyed by this module may also be separated in a further module. For example, the system may comprise a module configured to receive graphene-containing solids as a fluidised power in a carrier gas, and to separate the graphene from the carrier gas. As will be appreciated, the separation of graphene from a carrier gas may be performed in any suitable way, such as using a filter or using cyclonic separation. For example, the module may comprise a filter element or a cyclonic separation system as described herein.

The graphene collection module is suitably configured to draw graphene-containing solids from one or more other modules and to store the graphene-containing solids. For example, the graphene collection module may comprise a vacuum source and a cyclonic separator configured to extract graphene-containing solids from at least one plasma reactor module in a carrier gas using the vacuum source, and to separate the graphene-containing solids from the carrier gas in the cyclonic separator to store the graphene-containing solids.

It will be appreciated that a module may be configured only to draw graphene-containing solids from one or more other modules, but pass the graphene to another module for storage, alternatively or in addition to storage in the same module. For example, the system may comprise a graphene extraction module configured to extract graphene-containing solids from one or more other modules, such as one or more plasma reactor modules, and to provide the graphene-containing solids to a graphene storage means external to the graphene extraction module. For example, the system may comprise a graphene storage module configured to receive and store graphene-containing solids from one or more other modules, for example from one or more plasma reactor modules or one or more graphene collection or extraction modules as described.

A graphene collection module or a graphene extraction module may suitably be configured to extract graphene from more than one other module in the system, for example two or more plasma reactor modules. In embodiments, a graphene extraction or collection module may be configured to synchronise removal of graphene-containing solids from a plasma reactor system with operation a plasma reactor system as described herein to close a separation valve between a reaction chamber and a hopper, so that the plasma reactor system may be continuously operated during collection. Where more than one plasma reactor system or plasma reactor module is coupled to an extraction or collection module, removal of graphene-containing solids may be synchronised with the plasma reactor systems so that closing of respective separation valves in the plasma reactor systems is offset to allow collection from a hopper of one plasma reactor system whilst one or more other plasma reactor systems in the modular system continue to fill their respective hoppers. In other embodiments, removal of graphene-containing solids may be synchronised with the plasma reactor systems so that collection is performed from more than one plasma reactor system or plasma reactor module simultaneously.

A control module may be present in the modular system comprising a controller configured to communicate electronically, for example via a network, with one or more other modules of the plurality of modules to control operation of the other modules and/or to provide remote network access to analytical information such as sensor data. For example, the controller may be configured to operate one or more plasma reactor modules, or other elements of the system such as a hydrogen separator as described elsewhere herein. In this way, each module does not necessarily need to contain substantial control and networking capability in order to function with the other modules in the system. In some embodiments, the control module may be combined with another module in the system, for example a plasma reactor module may comprise a control module configured to communicate with and control or provide network access to other modules in the system.

A quality control module may suitably be configured to receive graphene-containing solids, and may comprise a Raman spectrometer configured to analyse the graphene-containing solids to determine a quality of graphene that is present. For example, a quality control module may be configured to analyse graphene containing solids by Raman spectroscopy as described previously herein.

A hydrogen storage module may be configured to receive a hydrogen-containing output gas from one or more other modules and to store the hydrogen. Hydrogen storage may be by any suitable means, such as by compression or by chemical storage.

It will be appreciated that the modular system may be arranged in various configurations, and may comprise any suitable number any types of modules depending on the desired use.

In a preferred embodiment, the system comprises a plurality of plasma reactor modules, with an inlet gas header configured to provide a hydrocarbon feed to each of the plasma reactor modules, wherein the hydrogen-containing output gas from each of the plurality of plasma reactor modules is combined to provide a common hydrogen output gas flow and the graphene-containing solids from each of the plurality of plasma reactor modules are collected in a common graphene storage means such as a graphene storage module, for example using a graphene collection module or a graphene extraction module as described herein.

In a preferred embodiment, the modular system may comprise a hydrogen separation module configured to receive the hydrogen-containing output gas from one or more plasma reactor modules and to separate hydrogen from hydrocarbons in the hydrogen-containing output gas to provide a hydrogen product stream and a hydrocarbon product stream, wherein at least a portion of the hydrocarbon product stream, in some embodiments substantially all of the hydrocarbon product stream, is recirculated to provide at least a portion of the feed stream to the one or more plasma reactor modules. Preferably, the system also comprises a power module to convert hydrogen in the hydrogen product stream into electricity, which may be used to provide power to one or more plasma reactor modules, or to provide power to an external system or power grid.

It will be appreciated that the output of hydrocarbons in the hydrocarbon product stream will be less than is input into a plasma reactor system from which it is derived (because some of the hydrocarbons have been converted to hydrogen and graphene-containing solids). Thus, in some embodiments, the hydrocarbon product stream derived from a first plasma reactor module may be provided to a second plasma reactor module that operates with a lower feed gas and/or process gas flow than the first plasma reactor module (for example operating the plasma reactor system at lower power), which may allow the hydrocarbon product stream to be converted to hydrogen and graphene-containing solids with minimal additional power input.

In a preferred embodiment, the modular system may comprise one or more plasma reactor modules and a power module, wherein the power module is configured to generate electricity to power the plasma reactor modules using a portion of the same hydrocarbon feed stream that is provided to the plasma reactor modules. Thus, the modular system may in some embodiments operate with only a hydrocarbon feed stream, as all electrical power can be provided using the hydrocarbons by the modular system itself. In some embodiments, at least a portion of the hydrogen-containing output gas from the plasma reactor module may be used to minimise the amount of hydrocarbons required by the power module, for example in order to minimise carbon emissions from combustion of hydrocarbons.

In another preferred embodiment, the modular system may comprise one or more plasma reactor modules and a module configured to receive graphene-containing solids (from the one or more plasma reactor modules) and a carrier gas, such as the hydrogen-containing output gas (from the one or more plasma reactor modules) or a hydrocarbon-containing gas from the hydrocarbon source, and to convey the graphene-containing solids along a pipeline as a fluidised powder using the carrier gas. For example, the modular system may be configured for operation at a source of natural gas, such as an offshore rig or an onshore drilling site, wherein the one or more plasma reactor modules are configured to produce hydrogen and graphene-containing solids from the natural gas, and wherein the system comprises a module configured to convey the graphene-containing solids along a pipeline using the natural gas (and optionally hydrogen). Thus, the system may be located at a source of natural gas and may convey graphene-containing solids along an existing natural gas pipeline using the natural gas as a carrier gas. Hydrogen produced by the plasma reactor module may suitably be used as part of the carrier gas or may be used to generate electricity for one or more plasma reactor modules without carbon emissions. In some preferred embodiments, for example at an offshore natural gas rig or platform, electricity may be provided to power the one or more plasma reactor systems using renewable power, such as wind power. Optionally, the system may further comprise a module configured to receive the graphene-containing solids as a fluidised power in the carrier gas, and to separate the graphene-containing solids from the carrier gas, for example a module located on-shore and configured to receive graphene-containing solids as a fluidised power in a natural gas stream from an offshore platform or rig.

A further aspect provides a system for producing a reduced-carbon gas blend from a hydrocarbon gas supply flow, the system comprising: a plasma reactor system configured to receive a feed stream comprising hydrocarbons, the feed stream comprising a portion of the hydrocarbon gas supply flow, and to provide a hydrogen-containing output gas and graphene-containing solids; and means for blending at least a portion of the hydrogen-containing output gas into the hydrocarbon gas supply flow to provide a reduced-carbon gas blend. Thus, the system can be configured to draw, for example, natural gas from a distribution pipeline, to convert a portion of the natural gas into hydrogen, and to provide hydrogen (and optionally any remaining natural gas or methane) back into the distribution pipeline. For example, the system may be provided at a site where natural gas is combusted to provide power, where the system is configured to decarbonise the natural gas provided downstream for combustion by converting hydrocarbon gas into hydrogen and graphene.

As will be appreciated, the plasma reactor system and other elements of the system of this aspect may comprise a portable containerised apparatus as described previously herein or a modular system as described previously herein.

The system preferably comprises a hydrogen separator configured to separate the hydrogen-containing output gas to provide a hydrogen product stream and a hydrocarbon product stream, the system configured to blend at least a portion of the hydrogen product stream into the hydrocarbon gas supply flow. As will be appreciated, the system may therefore comprise a plasma reactor module and a hydrogen separation module as described previously herein. The system is preferably configured to recirculate at least a portion of the hydrocarbon product stream to provide at least a portion of the feed stream to the plasma reactor system.

The system may be configured to control the amount of hydrogen that is blended into the hydrocarbon gas supply flow to provide a reduced-carbon gas blend by monitoring and/or controlling the relative proportions, e.g. the relative pressures, of the hydrogen-containing output gas and the hydrocarbon gas supply flow. Thus, in preferred embodiments, the system comprises means for controlling a proportion of the hydrocarbon gas supply flow to be directed to the plasma reactor system, and/or means for controlling a proportion of hydrogen in the reduced-carbon gas blend.

The means for controlling a proportion of hydrogen in the reduced-carbon gas blend may comprise a hydrogen separator configured to control a proportion of the hydrogen-containing output gas or a separated hydrogen product stream that is blended into the hydrocarbon gas supply flow. Preferably, the means for controlling a proportion of hydrogen in the reduced-carbon gas blend comprises pressure sensors configured to monitor pressure of the hydrocarbon gas supply flow and the hydrogen-containing output gas or hydrocarbon product stream, wherein the sensed pressures are used to maintain a desired proportion of hydrogen in the reduced-carbon gas blend. In this way, a downstream use of the reduced-carbon gas blend may for example be configured for using natural gas having a predetermined proportion of hydrogen in the gas, where the present system can monitor and maintain the required level of hydrogen in the reduced-carbon gas blend, such as preventing the hydrogen content of the reduced-carbon gas blend exceeding a predetermined threshold.

A further aspect provides a system for transporting graphene through a pipeline comprising: a plasma reactor system configured to receive hydrocarbons from a hydrocarbon source and to provide a hydrogen-containing output gas and graphene-containing solids; means for blending the graphene-containing solids with a carrier gas and convey the graphene-containing solids through a pipeline as a fluidised powder using the carrier gas. Preferably, the system comprises a portable containerised apparatus comprising the plasma reactor system. As will be appreciated, the plasma reactor system or portable containerised apparatus, or other elements of the system may be as described herein, for example a modular system as described herein.

Preferably, the carrier gas comprises at least a portion of the hydrogen-containing output gas or a hydrocarbon-containing gas from the hydrocarbon source, such as natural gas. Preferably, the pipeline comprises a natural gas pipeline and the graphene-containing solids are conveyed through the pipeline by a flow of natural gas. For example, the system may be provided at an offshore natural gas rig or platform, wherein the pipeline comprises a pipeline from the offshore rig/platform to an on-shore location.

In preferred embodiments, the carrier gas comprises or consists essentially of the hydrogen-containing output gas, or the carrier gas comprises or consists essentially of natural gas and optionally the hydrogen-containing output gas.

The system may suitably further comprise means for separating the graphene-containing solids from the carrier gas at a downstream location along the pipeline. For example, at an on-shore location for receiving the fluidised powder comprising the carrier gas and graphene from an offshore platform/rig.

While graphene is mentioned specifically throughout the present disclosure, it will be appreciated that various carbon-based solids may be formed including graphene. For example, other graphitic solids such as graphite may be formed, or other carbon-based solids such as carbon black or activated carbon. In some instances, the apparatus may be configured to produce carbon nanomaterials such as carbon nanotubes, for example using a plasma reactor and a catalyst as described in WO 2017/103588 A1. As will also be appreciated, while graphene and graphene-containing solids are mentioned specifically, the various aspects of the present disclosure may in some embodiments relate to producing hydrogen whilst producing carbon-based solids in general, which may include graphene or may include one or more other carbon-based materials such as carbon nanotubes as discussed, for example the portable containerised apparatus, and the plasma reactor system, may be configured to produce hydrogen whilst producing carbon-based solids in general and not necessarily graphene.

### BRIEF DESCRIPTION OF FIGURES

Embodiments of the invention will now be described, by way of example only, and with reference to the drawings in which:

FIGS. 1a and 1b show opposing views of the interior of a portable containerised apparatus;

FIG. 2 shows a reaction chamber of a plasma reactor system;

FIGS. 3a and 3b show sectional views of a planar filter element;

FIG. 4 shows a plasma reactor system comprising a scraper arm and motor;

FIG. 5 shows a sectional view of a separation valve and hopper;

FIGS. 6a and 6b show a sectional view of a cyclonic separation system;

FIGS. 7 and 8 show schematic arrangements of a portable containerised apparatus and a hydrogen separator;

FIGS. 9 and 10 show schematic arrangements of a portable containerised apparatus and a hydrocarbon source;

FIG. 11 shows a schematic arrangement of a portable containerised apparatus and a hydrogen separator;

FIG. 12 shows a schematic arrangement of two portable containerised apparatuses;

FIGS. 13 and 14 show schematic arrangements of a portable containerised apparatus where graphene-containing solids from the apparatus are conveyed by a carrier gas;

FIG. 15 shows a schematic arrangement of multiple portable containerised apparatuses arranged in parallel;

FIGS. 16a and 16b show schematic arrangements of portable containerised apparatus with a power module;

FIGS. 17 to 18 illustrate methods of operating a portable containerised apparatus; and

FIG. 19 shows a schematic view of an example plasma nozzle providing multiple vortices in the process gas.

In the drawings like reference numerals are used to indicate like elements.

### DETAILED DESCRIPTION

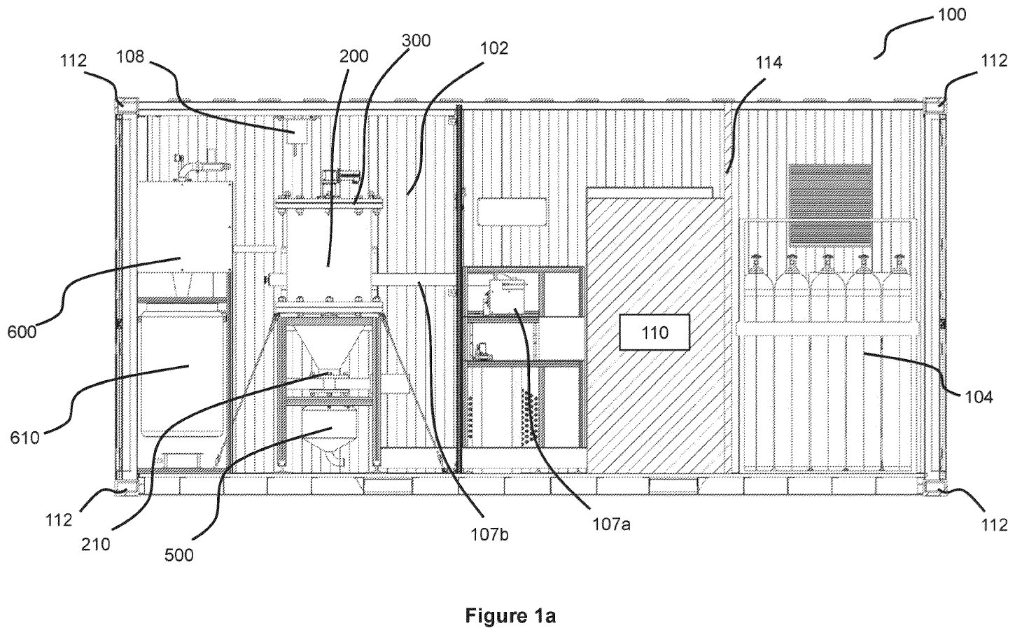

By way of overview, FIGS. 1a and 1b show a portable containerised apparatus 100 for producing hydrogen and graphene from a hydrocarbon source, the apparatus comprising: a plasma reactor system 102 configured to produce hydrogen and graphene from a process gas comprising hydrocarbons; an inlet for receiving a feed stream comprising hydrocarbons from the hydrocarbon source and means for supplying the process gas to the plasma reactor system 102; a hydrogen outlet 108 for removing hydrogen from the containerised apparatus 100 and/or hydrogen storage means within the containerised apparatus 100, and means for providing a hydrogen-containing output gas from the plasma reactor system 102 to the hydrogen outlet 108 and/or the hydrogen storage means; and a graphene outlet for removing graphene-containing solids from the containerised apparatus 100 and/or graphene storage means 610 within the containerised apparatus 100, and means (e.g. cyclonic separation system 600) for providing graphene-containing solids from the plasma reactor system to the graphene outlet and/or the graphene storage means 610.

In particular, FIG. 1 shows a view of the interior of a portable containerised apparatus 100. The portable containerised apparatus comprises a shipping container than contains the various elements of the apparatus, where the apparatus is configured to operate in situ within the shipping container, i.e. without the need to remove and/or construct or set up the apparatus at a point of use.

The apparatus in FIG. 1 comprises an inlet (not shown) for receiving a hydrocarbon gas feed stream and hydrocarbon gas storage 104 comprising a plurality of pressurised gas cylinders for storing hydrocarbon-containing gases, such as natural gas, at elevated pressure, for example at about 18 bar (although other pressures may be used). The hydrocarbon gas storage 104 is optional and the apparatus may in some instances use only a hydrocarbon gas feed stream received at the inlet. Nonetheless, the hydrocarbon storage 104 may be advantageous where a discontinuous supply of feed gas is available at the inlet, where the hydrocarbon storage 104 may be used to store hydrocarbon gas received at the inlet to enable continuous operation. For example, where a feed stream is available only for a certain time period each day, the hydrocarbon storage 104 can be used to store hydrocarbon gas from the inlet during that time period (in addition to using gas from the inlet for operation of the apparatus) and the stored hydrocarbon gas used to provide process gas when external feed gas is unavailable (for example to provide 24 hour operation using a discontinuous feed supply). The apparatus 100 includes a pressure sensor (not shown) configured to monitor the pressure of the feed stream to the apparatus. The apparatus comprises a regulator system for providing a process gas flow derived from the hydrocarbon gas in the feed stream and/or the hydrocarbon storage 104 to a plasma reactor system 102 (thus the hydrocarbons in the process gas may derive from the hydrocarbon storage 104 or directly from a feed stream to the inlet of the apparatus 100).

The regulator system comprises a gas compressor 106 for increasing the pressure of the feed stream to the apparatus, and it will be appreciated that the regulator system, whilst not explicitly shown, may also suitably comprise means for regulating pressurised feed gas, and/or pressurised gas from the hydrocarbon storage 104, to provide the process gas flow to the plasma reactor system 102. The regulator system is configured to receive the feed stream and, based on the pressure of the feed stream, to increase its pressure, for example using compressor 106, for storage in storage 104 or where the feed stream is at a pressure that is too high, to reduce the pressure of the feed stream for storage or providing directly to the plasma reactor system 102 in the process gas. Thus, the regulator system may comprise an upstream portion that comprises a gas compressor 106 and a gas pressure regulator for regulating the pressure of an incoming feed stream to the apparatus 100. The regulator system also comprises a downstream portion that regulates gas flow from the hydrocarbon storage 104 or the feed stream inlet (for example gas flow from the gas compressor 106) to provide the process gas at the desired pressure, for example at or slightly above atmospheric pressure such as from 1.0 to 1.5 bar.

Nonetheless, it will be appreciated that the process gas pressure may vary depending on the requirements of the system. Thus, the regulator system suitably comprises a number of components that may be disposed in different locations within the apparatus 100, for example a compressor 106 and pressure regulator of the upstream portion may be disposed adjacent the inlet for receiving the feed stream, while a further pressure regulator may be disposed elsewhere in the apparatus, such as between the inlet or hydrocarbon storage 104 and the plasma reactor system 102. The regulator system is controlled by a controller 110, configured to monitor the pressure of an incoming feed stream at the inlet, and to control the regulator system to store the hydrocarbon gas at 104 and/or to provide the process gas to the plasma reactor system 102 at the required pressure and flow rate, which may be pre-programmed and/or changeable using a user interface of the controller 110 located within the apparatus 100 or remotely via a network connection to the controller 110.

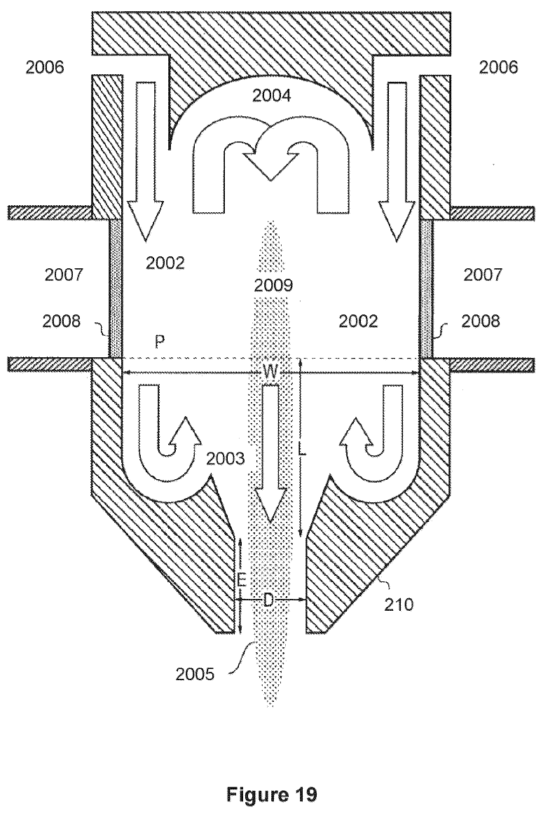

The regulator system (from the downstream portion) is configured to provide the process gas to a plasma nozzle 2000 of the plasma reactor system 102 via a conduit (not shown). The plasma reactor system comprises a reaction chamber 200 coupled to the plasma nozzle 2000 to receive cracked hydrocarbon species from the plasma nozzle 2000. The plasma reactor system 102 comprises a microwave generator 107a comprising magnetron and an electrical power source, and a waveguide 107b for providing microwave radiation to the plasma nozzle 2000. FIG. 19 is a simplified drawing of an exemplary plasma nozzle 2000 and shows how multiple vortices such as a triple vortex may be formed. Process gas enters through air knives 2006, spirals down along the wall 2002 and through a dielectric tube 2008, where it is subjected to the microwave radiation exiting the wave guide 2007 (e.g. wave guide 107b). Along the taper 2003, a counter vortex is created by the plasma finder 2004 via the Coanda effect in the opposite direction on the inside of the first vortex, subjecting the gas stream to the microwave for the second time. The plasma finder 2004 finally sends the gas back through the microwave for the third time. The plasma 2009 is thus contained in the centre part of the nozzle, the outer two vortices protecting the tube from getting into contact with the plasma. The plasma afterglow 2005 from the plasma nozzle 2000, which may include cracked hydrocarbon species, recombined hydrocarbon species and hydrogen, enters the reaction chamber 200 where hydrogen and graphene-containing solids are formed (it will be appreciated that in some instances, some recombination of cracked species to form hydrogen and carbon-based solid material may also occur in the nozzle prior to entering the reaction chamber, however this is not required and in other instances substantially no recombination to form solid material takes place in the nozzle). As will be appreciated, depending on the conversion efficiency of the process gas in the plasma nozzle 2000, the gas inside the reaction chamber may comprise hydrogen as well as unreacted process gas, i.e. hydrocarbon gas. Thus, a hydrogen-containing output gas from the reaction chamber may suitably comprise hydrogen and hydrocarbon gases.

The plasma reactor system 102 comprises a planar filter element 300 above the reaction chamber 200. The planar filter element 300 separates the reaction chamber from a gas outlet 304 for providing hydrogen-containing output gas from the plasma reactor system to a hydrogen outlet 108 through which the hydrogen-containing output gas may leave the apparatus 100. The planar filter element 300 permits the plasma reactor system 102 to be disposed inside the containerised apparatus 100 whilst maintaining a larger size of the reaction chamber 200, permitting the rate of hydrogen and graphene output from the apparatus to be maintained.

The plasma reactor system 102 also comprises a hopper 500 arranged below the reaction chamber 200 to receive graphene-containing solids from the reaction chamber via a graphene removal port 210 comprising a separation valve for isolating the hopper 500 from the reaction chamber 200. The hopper 500 is coupled to a cyclonic separation system 600 that is configured to draw graphene-containing solids from the hopper into a graphene storage container 610 (for ease of representation, the connection between the hopper 500 and the cyclonic separation system 600 is omitted in FIG. 1). As will be appreciated, the configuration of the apparatus to draw graphene from the hopper 500 to a separate storage container 610 permits the apparatus 100 to store an increased amount of graphene-containing solids whilst permitting the hopper 500 to be of a small enough size to be arranged below the reaction chamber 200 within the containerised apparatus 100. While a graphene storage container 610 is shown in FIG. 1, it will be appreciated that the apparatus 100 may alternatively or additionally include a graphene outlet through which graphene-containing solids can leave the apparatus 100 (which may via the cyclonic separator 600, directly from the hopper 500, or directly from the graphene removal port 210).

The apparatus 100 may comprise attachment means 112 at corners of the apparatus 100 (i.e. at corners of the container) configured to permit the apparatus to be attached to other containers for transport or for assembling a modular system at a point of use. The attachment means may comprise twist lock fittings configured to receive twist locks such as are commonly used in the art to connect shipping containers. it will be appreciated that the elements of the apparatus will be fixed in place, or at least fixable in place, for transport of the apparatus. For example, various elements of the apparatus 100 may be fixed to the floor, the side walls or ceiling within the container which fixing may be direct such as bolting or securing with tethers, or may be indirect in that some elements of the apparatus 100 may be fixed to another part of the apparatus that is itself directly fixed in place within the apparatus.

The apparatus 100 as shown in FIGS. 1a and 1b has a dividing wall 114 within the apparatus that separates the hydrocarbon storage 104 from the plasma reactor system 102 and the controller 110. In this way, the high pressure and flammable gases in the hydrocarbon storage 104 are isolated from other elements of the apparatus 100 in case of leaks. In addition, the side of the apparatus 100 comprising the controller 110 may comprise a user interface, and the dividing wall 114 increases safety by providing a barrier between the pressurised hydrocarbon gases and the part of the apparatus 100 where a user would be located in order to use the user interface to control the apparatus 100. This can also provide a barrier between storage of inert gases such as nitrogen or argon that are stored under pressure with the hydrocarbon storage 104, and if released into the container with a user could cause an asphyxiation risk, along with methane. In addition, the dividing wall 114 provides a barrier between the compressed gases and the plasma reactor system 102, which may aid in detecting gas leaks from the plasma reactor system 102, for example using one or more gas sensors inside the container in communication with the atmosphere around the plasma reactor system. Nonetheless, it will be appreciated that a dividing wall such as wall 114 may in some instances not be present, for example where no hydrocarbon storage is used and an external feed stream is used to provide hydrocarbons for the process gas. Thus, while hydrocarbon storage 104 is shown in FIG. 1, in general it will be appreciated that the hydrocarbon storage is optional and the apparatus may in some instances not include hydrocarbon storage.

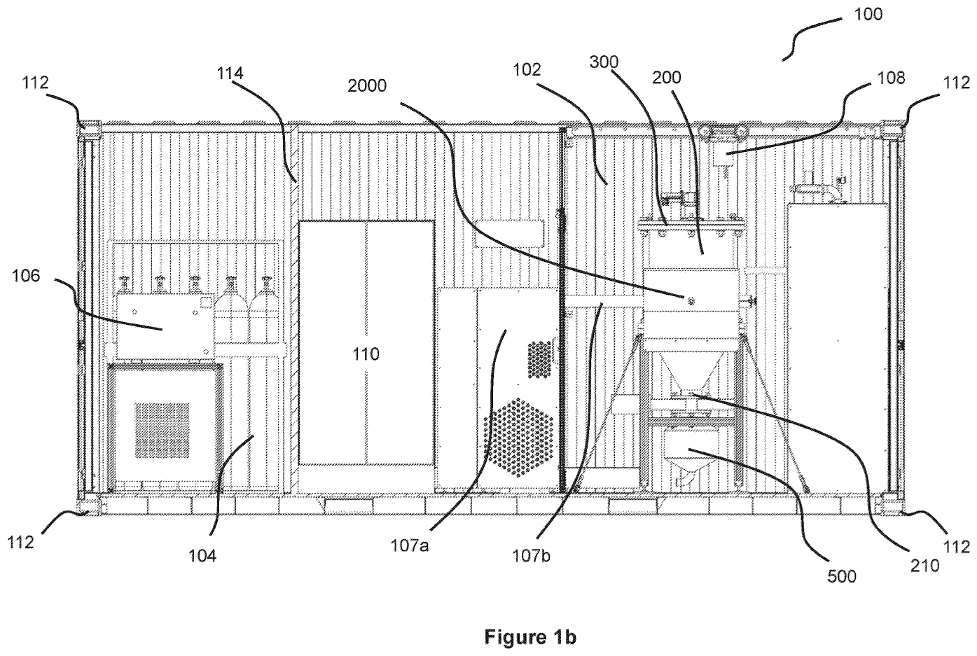

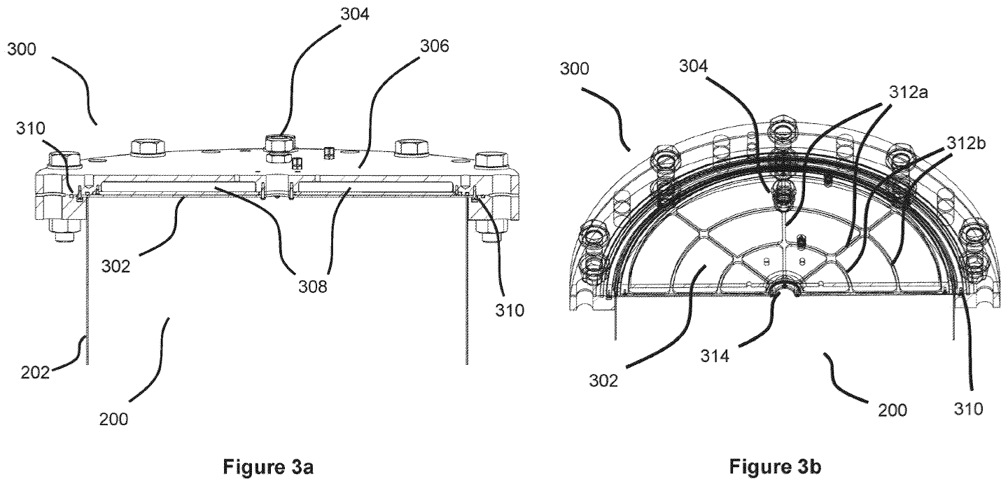

FIG. 2 shows a view of the reaction chamber 200 of the plasma reactor system 102. The reaction chamber 200 comprises a substantially cylindrical portion bounded by a cylindrical side wall 202 and a flat upper wall 206, and a tapered portion bounded by a conical side wall 204. The reaction chamber 200 includes a scraper arm 400, which is described in more detail in relation to FIG. 4. The graphene removal port 210 is disposed below the reaction chamber 200 and the conical side wall 204 is tapered towards the graphene removal port 210 to direct graphene-containing solids in the reaction chamber to the graphene removal port 210 under gravity. The reaction chamber is coupled to the plasma nozzle 2000 though the side wall 204 at a lower end of the side wall 204 (though it will be appreciated that the position of one or more plasma nozzles on the reaction chamber 200 may be suitably varied). The tapered portion of the reaction chamber 200 formed by conical side wall 204 is below the coupling to the plasma nozzle 2000 in the reaction chamber such that hot gases formed during recombination of cracked species in the afterglow from the plasma nozzle 2000 rise towards the upper end of the reaction chamber 200. In this way, the temperature in the tapered portion may be maintained at a lower temperature than the reaction chamber above so that graphene accumulating at the lower end of the reaction chamber (for example when the graphene removal port 210 is closed) is in a lower temperature environment, reducing degradation of the graphene.

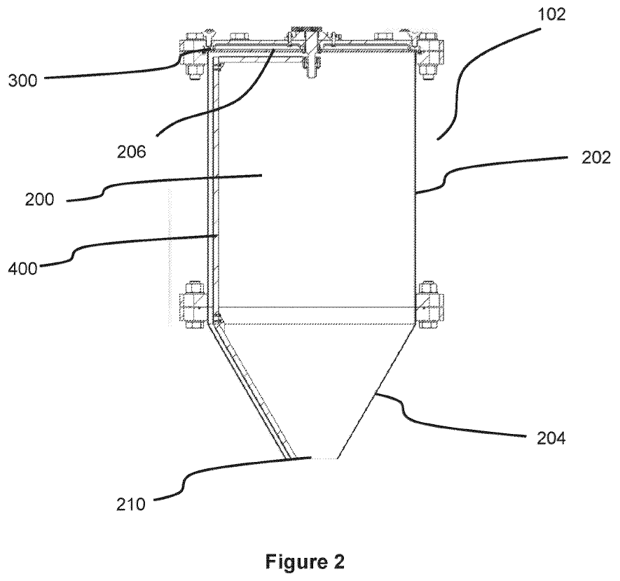

FIGS. 3a and 3b show views of the planar filter element of the plasma reactor system 102. As shown in FIG. 3a, the planar filter element 300 comprises a filtration means 302 that forms an upper wall of the reaction chamber 200 where the filtration means 302 extends across the reaction chamber 200 from the side walls 202 to provide the entire flat upper wall 206 of the reaction chamber 200. The filtration means 302 separates the interior of the reaction chamber 200 from the gas outlet 304 to remove solids from the hydrogen-containing output gas that passes to the gas outlet 304. In the specific embodiment shown in FIG. 3, the filtration means 302 comprises a 316L stainless steel or Hastelloy fibres, has a thickness of about ⅛ inch and is configured to remove particles having a size of greater than 11 μm from the gas. Nonetheless, it will be appreciated that the filtration means may comprise any suitable gas-permeable material that permits the hydrogen-containing output gas to pass to the gas outlet 304, whilst preventing passage of the graphene-containing solids in the reaction chamber 200. The filtration means 302 can be sealed around its periphery by one or more filter seals 310 to prevent leakage of gases in the reaction chamber and to hold the filtration means 302 in place.

The filter element 300 comprises a filter volume 308 that is disposed between, and separates the filtration means 302 from an outer wall 306 of the filter element 300. The filter volume 308 provides a chamber between the filtration means 302 and the gas outlet 306. As will be appreciated, while the filtration means 302 provides an upper wall 206 of the reaction chamber 200 through which solids are prevented from passing, the outer wall 306 provides an additional wall that is impermeable to gases and is configured to withstand and contain the gas pressure within the reaction chamber 200. The upper wall 306 comprises the gas outlet 304, which permits the hydrogen-containing output gas to leave the plasma reactor system 102 and pass to the hydrogen outlet 108. As shown in FIG. 3a, the filter volume 308 provides a cylindrical volume above the filtration means 302 that separates the filtration means 302 from the upper wall 306 and the gas outlet 304. The outer wall 306 is parallel with the filtration means so that the filter volume 308 has a constant height above the filtration means 302 to promote even flow of gas through the filtration means 302. The filter volume has a height of about 1.5 cm (relative to a reaction chamber diameter of about 60 cm), which can permit gas flow through the entire surface of the filtration means 302, whilst also preventing excessive cooling of the gases between the filtration means 302 and the gas outlet 304 to avoid precipitation of vapours on the filtration means 302.

As shown in FIG. 3b, the filter element 300 comprises a filter support 312, that comprises a plurality of struts 312a, 312b disposed on the filtration means 302 arranged for reducing deformation of the filtration means 302 due to pressure in the reaction chamber 200 and gas flow through the filtration means 302 to the gas outlet 304. The filter support comprises a plurality of radial support struts 312a and concentric circular support struts 312b disposed above the filtration means. As will be appreciated, whilst radial and circular support struts are shown in FIG. 3b, any suitable arrangement may be used. The filter element may comprise a central aperture 314, which can allow a scraper arm in the reaction chamber 200 to be coupled to a motor outside of the reaction chamber 200.

FIG. 4 shows another view of the plasma reactor system 102 and the reaction chamber 200. The reaction chamber 200 comprises a scraper arm 400 that extends along the internal walls of the reaction chamber 200 to permit material deposited on the walls to be removed. The scraper arm 400 comprises an upper arm portion 402 that extends along the flat upper wall 206 of the reaction chamber (i.e. along the filtration means 302) from the central aperture 314 of the filter element 300 to the side wall 202 of the reaction chamber. A lateral arm portion 404 extends down the side wall 202 of the reaction chamber from the upper wall 206 to the conical wall 204, and a lower arm portion 406 extends along the conical wall 204 from the side wall 202 to the graphene removal port 210. As shown in FIG. 4, the graphene removal port comprises a separation valve 212 (an orifice gate valve is shown, however any suitable valve may be used) configured to close the graphene removal port 210, for example to isolate the reaction chamber 200 from the hopper 500.

The scraper arm is coupled through the central aperture 314 of the filter element to a gearbox 408 and a servo motor 410 configured to rotate the scraper arm 400 around the periphery of the reaction chamber 200 to sweep the scraper arm across the surface of the upper wall 206 (i.e. a surface of the filtration means 302 facing the reaction chamber) the side wall 202 and the conical wall 204. The scraper arm 400 may be formed from a rigid and heat resistant material such as stainless steel and comprises one or more silicone inserts for contacting the walls of the reaction chamber 200.

The scraper arm 400 is configured to rotate about a vertical axis of the reaction chamber passing through the graphene removal port 210 to the central aperture 314. The gearbox 408 shown in FIG. 4 is an angular gearbox, which allows the servo motor 410 to be disposed horizontally and can reduce the vertical height of the plasma reactor system 102 in the container. The servo motor 410 can be communicatively coupled to the controller 110 to control operation of the scraper arm 400. The gearbox 408 and servo motor 410 can be coupled to the scraper arm 400 through the central aperture 314 via a shaft 412 extending vertically from the scraper arm through the central aperture 314. The scraper system is able to operate at elevated temperatures exceeding 200° C. and the shaft 412 is sealed to prevent gas leakage through the central aperture 314 using ceramic bearings and graphite shaft seal (graphite cord).

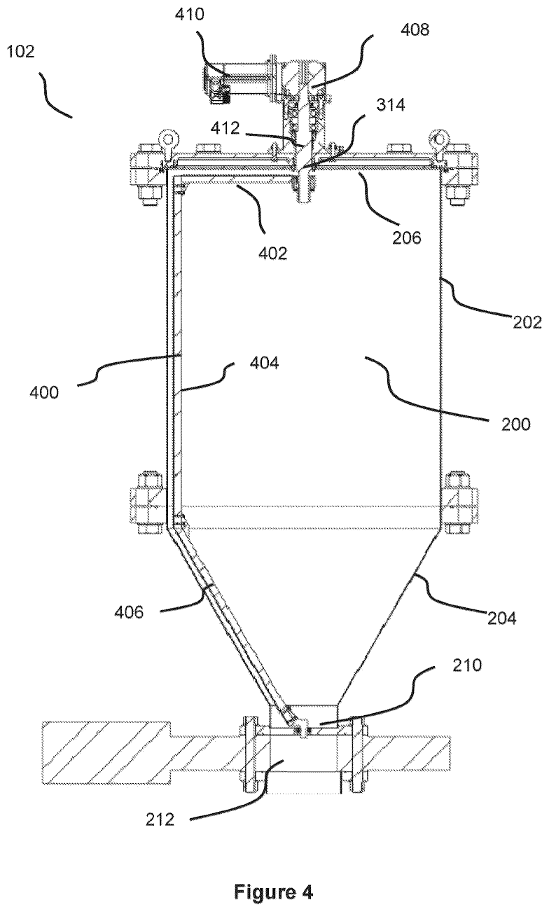

FIG. 5 shows a hopper 500 provided below the reaction chamber 200 and coupled to the reaction chamber 200 by the graphene removal port 210 such that when the separation valve 212 is open, graphene-containing solids in the reaction chamber 200 can fall under gravity from the reaction chamber 200 into the hopper 500 for collection. The tapered shape of the reaction chamber 200 (provided by conical wall 204) towards the graphene removal port 210 helps to funnel solids in the reaction chamber 200 into the hopper 500. When it is necessary to empty the hopper 500 of graphene-containing solids, the separation valve 212 is closed, isolating the hopper 500 from the reaction chamber 200 and preventing passage of material (solid or gaseous) from the reaction chamber 200 into the hopper 500.

While the hopper 500 is emptied and the separation valve 212 is closed, the plasma reactor system 102 continues to operate to produce graphene and hydrogen from the process gas. When the separation valve 212 is closed, the graphene-containing solids in the reaction chamber 200 accumulate on an upper surface 214 of the closed separation valve 212 at the graphene removal port 210. When the separation valve 212 is opened to resume collection in the hopper 500, graphene-containing solids accumulated on the upper surface 214 pass into the hopper 500 and collection in the hopper 500 resumes.

As shown in FIG. 5, the hopper 500 comprises an air inlet 502 and a purge gas inlet 504, and an exhaust passage 506 for removing graphene-containing solids from the hopper 500. The air inlet 502 is connected to a source of air, which may comprise a stored source of air in the apparatus 100 such as compressed air or may comprise means to provide ambient air from outside the apparatus 100 into the hopper 500, which means may simply comprise a conduit or may comprise a pump or compressor for providing a flow of air to the air inlet 502. The hopper 500 also comprises a purge gas inlet 504 that is connected to a source of purge gas, which comprises a store of inert gas within the apparatus 100, such as argon or nitrogen, which may be provided to the purge gas inlet by the regulator system. The exhaust passage 506 comprises an exhaust valve (not shown) configured to permit opening or closing of the exhaust passage 506, which may comprise a solenoid valve or any other suitable valve. Opening and closing of the air inlet 502, purge gas inlet 504 and exhaust valve may be controlled by the controller 110.

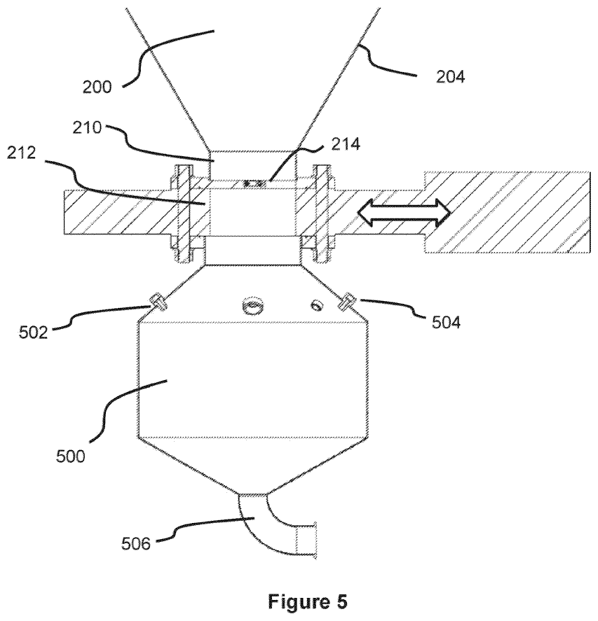

In order to empty the hopper 500, the separation valve 212 is closed, and the exhaust valve (exhaust passage 506) is opened. After closing the separation valve 212 but before opening the exhaust passage 506, the purge gas inlet 504 can be opened to provide a flow of inert gas into the hopper 500, which is vented from the hopper via an exhaust outlet (not shown). This purges flammable and explosive gases (e.g. hydrogen and hydrocarbon gas such as methane) from the hopper prior to removal of solids from the hopper 500. The air inlet 502 can then be opened and the exhaust valve opened to provide air to carry the graphene-containing solids, which are in the form of a powder, from the hopper 500 in a gaseous suspension through the exhaust passage 506. The step of purging the hopper with inert gas avoids mixing of flammable or explosive gases with oxygen in the hot and enclosed environment of the hopper 500 or downstream following removal. The cyclonic separation system 600 (described in more detail in relation to FIG. 6) is coupled to the hopper 500 via the exhaust passage 506 and configured to draw the graphene-containing solids from the hopper 500 with a carrier gas provided by air from the air inlet 502.

The hopper 500 may be emptied, for example, at set time intervals during operation of the system, in response to an indication to empty the hopper 500 from a user, or in response to an indication from a proximity sensor in the hopper 500 that the hopper contains a threshold amount of solid material. Monitoring and control of emptying of the hopper is performed by the controller 110, which can receive indications from a proximity sensor in the hopper 500 or instructions contained in a memory of the controller 110 or input by a user via a user interface or remotely via a network.

FIGS. 6a and 6b show sectional views of a cyclonic separation system 600 and graphene storage container 610. The cyclonic separation system 600 comprises a separator inlet passage 602 that is connected to the exhaust passage 506 of the hopper 500 for receiving graphene-containing solids from the hopper 500 in a suspension as a fluidised powder carried by air from the air inlet 502. The fluidised powder is provided to the cyclone separation chamber 606 via a cyclone inlet 604, wherein the cyclone inlet is arranged to induce a circulatory flow of the fluidised powder in the cyclone separation chamber 606 (as shown in FIG. 6b). The cyclone separation chamber 606 has a circular cross-section with curved chamber side walls 607 configured to direct flow from the cyclone inlet to induce the circulatory flow. The chamber side wall 607 is tapered from the cyclone inlet 604 towards a cyclone solids outlet 608 for providing graphene-containing solids to the graphene storage container 610. The cyclone separation chamber 606 also has a cyclone gas outlet port 612 at its upper end, opposite the solids outlet 608.

The circulatory flow within the cyclone separation chamber 606 causes the graphene-containing solids in the flow from the cyclone inlet 604 to be distributed radially outwards towards the side walls 607. The graphene-containing solids are funnelled towards and through the cyclone solids outlet 608 by the conical chamber side wall 607 into the graphene storage container 610. The cyclone gas outlet port 612 is arranged centrally with respect to, and extends down into, the cyclone separation chamber 606. The cyclone gas outlet port 612 is arranged to draw gas from a central volume of the cyclone separation chamber 606 that is surrounded by the circulatory flow. As the circulatory flow distributes solids radially outwards towards the side walls 607, the central volume contains a reduced proportion of the graphene-containing solids relative to flow from the cyclone inlet 604, thereby separating the graphene-containing solids from the carrier gas (e.g. the air from the air inlet 502 in the hopper 500) to provide a flow of separated solids 622 into the graphene storage container 610 and a flow of separated gas 624 through the cyclone gas outlet port 612 (as shown in FIG. 6b).

The flow from the hopper 500 to the cyclonic separation system 600 is provided by a vacuum source (not shown) that is connected downstream of the cyclone gas outlet port 612 for drawing a flow from the cyclone separation chamber 606 through the cyclone gas outlet port 612. The vacuum source is separated from the cyclone gas outlet port 612 by a vacuum valve, which may for example be a solenoid valve, and a candle filter 616. The cyclone gas outlet port 612 leads to a filter housing 614 containing a candle filter 616 configured to filter any remaining solids in the gas flow from the cyclone gas outlet port 612 to the vacuum source. Thus, the candle filter 616 separates the cyclone gas outlet port 612 from the vacuum valve 620 and the vacuum source. The candle filter 616 comprises a blowback valve 618 arranged to provide a reverse flow of air through the candle filter 616 to dislodge solids deposited on the surface of the candle filter 616. As will be appreciated, the blowback valve may only be operated when the vacuum source is off and/or the vacuum valve 620 is closed, which may be suitably controlled by the controller 110.

Operation of the hopper exhaust valve, the air inlet 502, the vacuum source, the vacuum valve 620 may suitably be controlled by the controller 110 to remove graphene-containing solids from the hopper 500 when the separation valve 212 is closed.

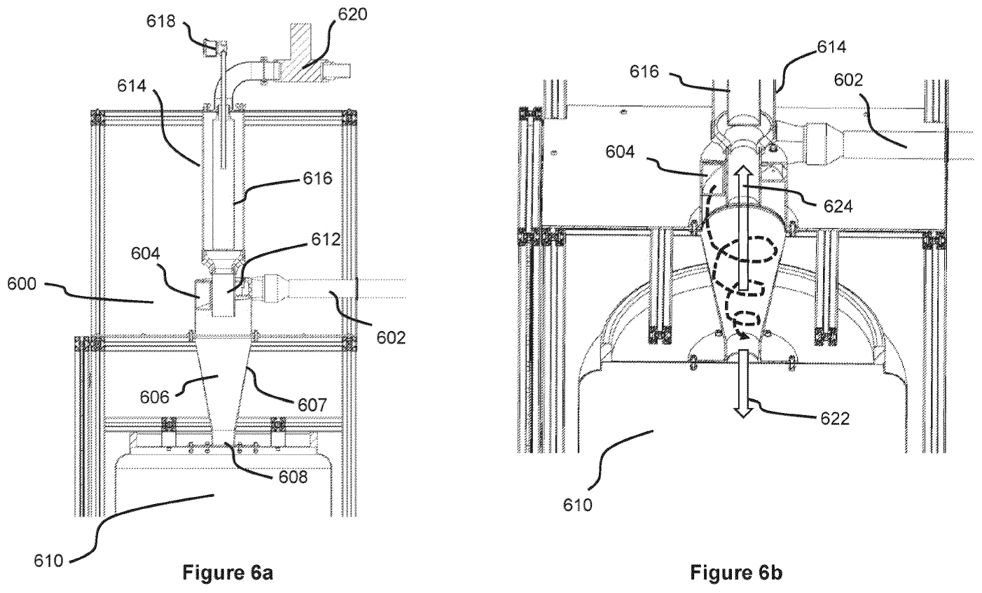

It will be appreciated that a portable containerised apparatus as described herein (e.g. the portable containerised apparatus 100) may be employed in a variety of configurations in combination with other equipment or other containerised modules for performing other functions. FIGS. 7 to 16 show schematically examples of a variety of preferred configurations or modular systems in which a portable containerised plasma reactor module 1 can be used. The portable containerised plasma reactor module 1 comprises a plasma reactor system configured to receive hydrocarbons from a hydrocarbon source and to provide a hydrogen-containing output gas and graphene-containing solids (for example as described herein and in relation to apparatus 100). As will be appreciated, the elements of the systems shown schematically in FIGS. 7 to 16 may be provided by a modular system comprising a plasma reactor module 1 and one or more other modules, which are preferably portable containerised modules. The systems illustrated in FIGS. 7 to 12 show a plurality of pressure sensors 6 which are coupled to a controller (e.g. controller 110) of the plasma reactor module 1 and/or to a separate control module (not shown) to monitor and control the flow of gas through the system. As will be appreciated, elements common to the systems shown in FIGS. 7 to 16 may be as described in relation to another figure unless indicated otherwise. As will also be appreciated, the systems shown in FIGS. 7 to 16 may comprise various pumps, compressors, valves, non-return valves and the like to ensure gas flow in the desired direction.

FIG. 7 shows a system 700 in which the plasma reactor module 1 receives a hydrocarbon feed stream 12 from a hydrocarbon source 8. While this is shown in FIG. 7 as a stream 12 drawn from a hydrocarbon flow 8 it will be appreciated that the hydrocarbon source 8 may be any suitable hydrocarbon source from which a feed stream 12 can be provided to the plasma reactor module 1. The hydrocarbon source may comprise natural gas, and preferably comprises methane, however the hydrocarbon source may include any source of hydrocarbon gases, such as a natural gas supply, waste gas, biogas, pure methane, or a mixture of hydrocarbons (e.g. a mixture of C₁ to C₂₀ hydrocarbons).

The pressure of the feed stream 12 is monitored with a pressure sensor 6, which may be part of the plasma reactor module 1 (e.g. at the inlet for receiving the feed stream 12) or may be external to the plasma reactor module 1. The plasma reactor module 1 receives electrical power from a power source 10, which may include any source of electricity (e.g. from an existing power grid, which may provide a green source of electricity) and in some instances may comprise a power module (which can be a portable containerised power module) configured to power the plasma reactor module 1 using the natural gas source 8 or hydrogen-containing gas or hydrocarbon gas from the plasma reactor module 1. A flow of graphene-containing solids 3 from a graphene outlet of the plasma reactor module 1 is provided to a graphene storage module 2, though it will be appreciated that graphene-containing solids may alternatively or additionally be stored in the plasma reactor module 1 in some instances. The graphene storage module 2 may comprise a cyclonic separator system (such as cyclonic separator system 600) configured to draw graphene-containing solids from the plasma reactor module 1.

The system 700 comprises a hydrogen separation module 4, which may comprise a separate (e.g. portable and containerised) hydrogen separation module, or may comprise a hydrogen separator that forms part of the plasma reactor module 1, for example within the container of a portable containerised plasma reactor module. The hydrogen separation module 4 receives a flow of hydrogen-containing output gas 5 from the plasma reactor module 1, and separates the hydrogen-containing output gas into a hydrogen product stream 16 and a hydrocarbon product stream 14 that is recirculated and provided to the inlet of the plasma reactor module 1 with the feed stream 12. While FIG. 7 shows the entire hydrocarbon product stream 14 being recirculated, in some instances only a portion of the hydrocarbon product stream 14 is recirculated with the remainder sent for downstream use together with or separately from the hydrogen product stream 16 or returned to the hydrocarbon source 8. The pressure sensors 6 monitoring the feed stream 12 and the recirculated hydrocarbon product stream 14 can be used to ensure that the recirculated hydrocarbon product stream 14 is at a pressure that is higher than the feed stream pressure to permit blending of the recirculated hydrocarbon product stream 14 into the feed stream. For example, the system 700 may comprise a compressor configured to compress the recirculated hydrocarbon product stream 14 to a higher pressure than the feed stream 12, which may be controlled by a controller (e.g. controller 110 or a control module) that receives information from the pressure sensors 6.

FIG. 8 shows a system 800 similar to the system 700, where the hydrocarbon source 8 is a hydrocarbon gas supply flow. In system 800 the hydrogen separation module 4 is configured to blend at least a portion of the hydrogen product stream 16a back into the hydrocarbon gas supply flow downstream of where the feed stream 12 is drawn from, to produce a reduced-carbon gas blend 18 comprising hydrocarbons and hydrogen. The hydrogen product stream 16a may include all of the hydrogen from the hydrogen separation module or optionally only a portion of the separated hydrogen, with the remainder provided as a second hydrogen product stream 16b. The system 800 can provide a reduced-carbon gas blend 18 having a substantially constant hydrogen content (for example a hydrogen content not higher than a desired threshold) by monitoring the pressure of the hydrocarbon gas supply flow and the hydrogen product stream 16a, and where necessary diverting a portion of the hydrogen product stream away from the hydrocarbon gas supply flow as stream 16b. The hydrogen separation module 4 may be controlled by a controller (e.g. controller 110 or a control module), based on the measurements from the pressure sensors 6, to maintain a desired level of hydrogen in the reduced-carbon gas blend 18. In this way, a user of the reduced-carbon gas blend 18 can avoid the need to modify existing equipment for using the gas blend 18 such as by combustion to provide heat and/or power, e.g. for a boiler or a turbine.

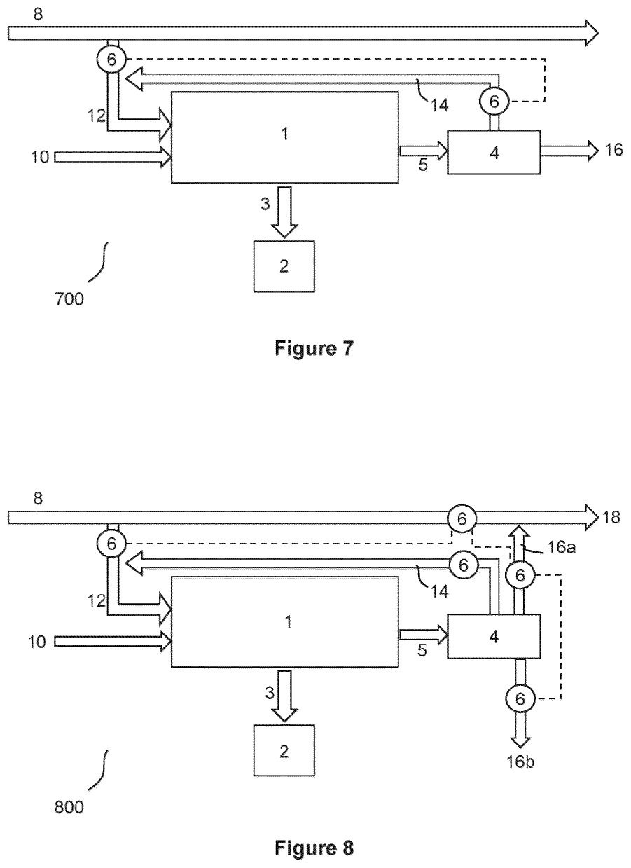

FIG. 9 shows another system 900 in which the hydrogen-containing output gas flow 5 from the plasma reactor module 1 is output for direct downstream use, such as by combustion to provide heat and/or power, e.g. for a boiler or a turbine. The composition of the hydrogen-containing output gas flow 5 may be controlled by the plasma reactor module 1, for example by controlling the conversion efficiency of the plasma reactor system (e.g. by adjusting flow rates of process gas and/or power provided for producing plasma), to provide a desired level of hydrogen in the hydrogen-containing output gas flow 5. Pressure sensors 6 and/or one or more other gas sensors may be used to monitor the gas flows and allow an end user to control the level of hydrogen by using the hydrogen-containing output gas flow 5, or where necessary blending with the hydrocarbon source gas 8 and/or providing information to a controller of the plasma reactor module 1 to adjust hydrogen content in the hydrogen-containing output gas flow 5.

FIG. 10 shows another similar system 1000 in which a hydrogen-containing output gas flow 5 from the plasma reactor module 1 is fed back into a hydrocarbon gas supply flow 8 downstream of where the feed stream 12 is drawn from, to produce a reduced-carbon gas blend 18 comprising hydrocarbons and hydrogen. It will be appreciated that a system may comprise a combination of systems 900 and 1000 such that the hydrogen-containing output gas flow 5 is split with a portion being blended into the hydrocarbon gas supply flow 8 and another portion being separately sent for downstream use without blending with the hydrocarbon gas supply flow 8.

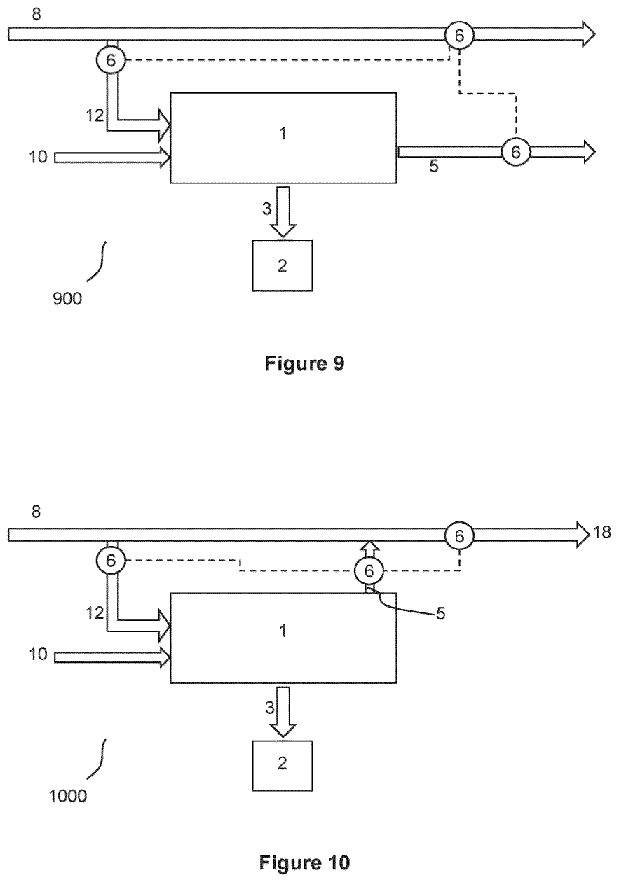

FIG. 11 shows a system 1100 in which a feed stream 12 is provided to a plasma reactor module 1 from a hydrocarbon source 8. In FIG. 11, the hydrogen-containing output gas flow 5 is separated by a hydrogen separation module 4 to provide a hydrogen product stream 16a/16b and a hydrocarbon product stream 14. A portion of the hydrogen product stream 16a is blended with the hydrocarbon product stream 14 to provide a reduced-carbon gas blend 18 for downstream use, such as by combustion to provide heat and/or power, e.g. for a boiler or a turbine. Another portion of the hydrogen product stream 16b is separately provided for storage or direct use for example by combustion or as 16b is a hydrogen stream, power generation with a hydrogen fuel cell. As will be appreciated, the balance of hydrogen flow between 16a and 16b (which may be monitored and controlled based on pressure sensors 6) may be used to control the level of hydrogen in the reduced-carbon gas blend 18.

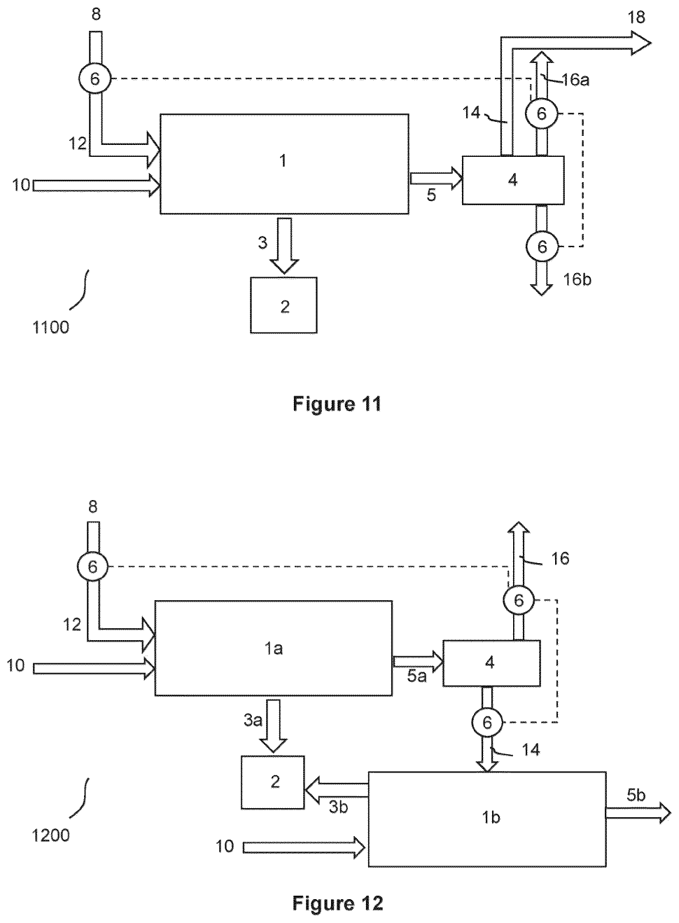

FIG. 12 shows a system 1200 comprising a first plasma reactor module 1a and a second plasma reactor module 1b. A first hydrogen output gas flow 5a from the plasma reactor module 1a is separated in a hydrogen separation module 4 to provide a hydrogen product stream 16 and a hydrocarbon product stream 14. The hydrocarbon product stream 14 is provided as a feed gas to an inlet of a second plasma reactor module 1b, and may be compressed and/or regulated and passed through one or more non-return valves. The second plasma reactor module 1b provides a second hydrogen containing output gas 5b, which may comprise a mixture of hydrocarbons and hydrogen, or may consist essentially of hydrogen, and a second graphene-containing solids flow 3b which is provided to graphene storage 2 together with the first graphene-containing solids flow 3a from the first plasma reactor module 1a (though it will be appreciated that separate graphene storage means may also be used). The second plasma reactor module 1b may be substantially the same as, or may be different to, the first plasma reactor module 1a. For example, the second plasma reactor module may be smaller in terms of gas flow into and through the module, such as by operating the plasma reactor system in 1b at lower pressure or using a smaller reaction chamber or plasma nozzle. It will be appreciated that because the feed to the second plasma reactor module 1b is only a portion of the hydrocarbons providing in the feed stream 12 to the first plasma reactor module 1a, the second plasma reactor module 1b may therefore operate using less electrical power than the first plasma reactor module 1a (and/or may be physically smaller and more efficient to transport to a point of use), boosting efficiency compared to using two equivalent plasma reactor modules.

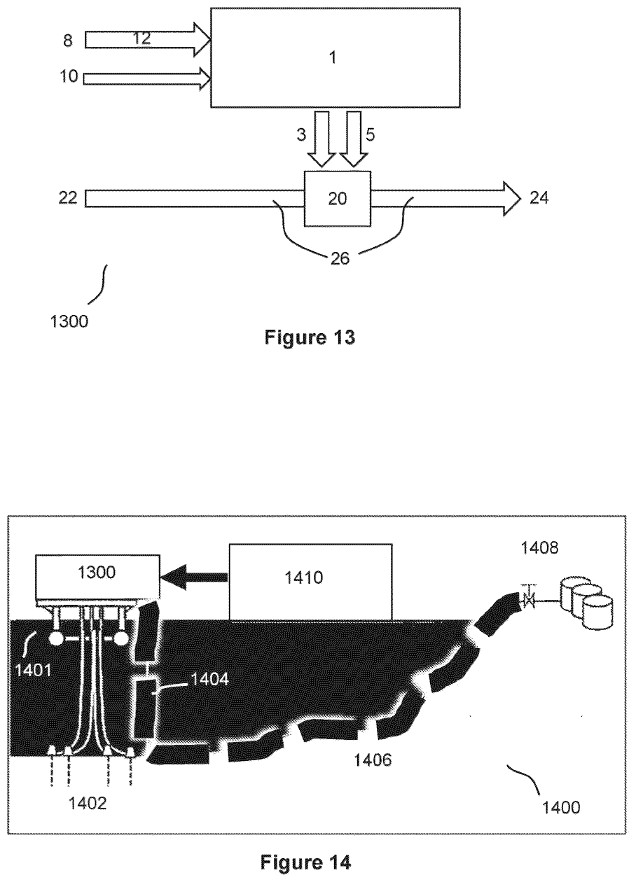

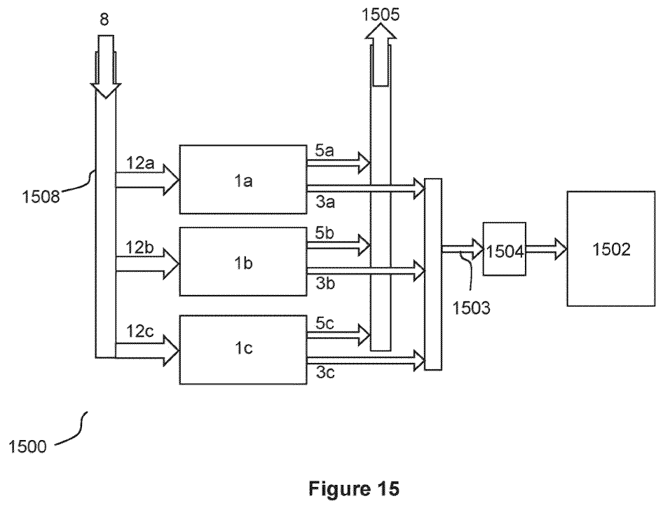

FIG. 13 shows a system 1300 in which a hydrocarbon feed stream 12 is provided to a plasma reactor module 1 from a hydrocarbon source 8. As shown in FIG. 13, a graphene-containing solids flow 3 and a hydrogen containing output gas flow 5 from the plasma reactor module 1 are provided to a conveying module 20. The conveying module 20 is configured to receive the graphene-containing solids 3 and a carrier gas 22, and to convey the graphene-containing solids 3 along a pipeline 26 as a fluidised powder flow 24 using the carrier gas. Whilst FIG. 13 shows the hydrogen-containing output gas 5 also being passed to the conveying module 20 to form at least a portion of the carrier gas, in some examples the carrier gas 22 may comprise a separate source of carrier gas that does not include the hydrogen-containing output gas 5 (which may be passed for downstream use elsewhere such as by combustion to provide heat and/or power). The carrier gas may comprise any suitable gas source and in some examples the carrier gas source 22 may comprise the hydrocarbon source 8, such that hydrocarbon gas, e.gt. natural gas, may be provided as the feed stream 12 to the plasma reactor module 1, and also provided to a conveying module 20 to act as the carrier gas. In some examples, the carrier gas source 22 may be omitted and the carrier gas may be provided by the hydrogen-containing output gas 5. The hydrogen containing output gas 5 may be used at least as an intermediate carrier gas to convey graphene containing solids 3 from the plasma reactor module 1 to the conveying module 20 for example where the graphene containing solids 3 and the hydrogen output gas leave the plasma reactor module 1 through a common outlet. Alternatively or in addition, another intermediate carrier gas such as air or an inert gas may be used to convey the graphene-containing solids 3 to the conveying module 20. The conveying module 20 may comprise one or more compressors and/or pumps configured to provide a flow of carrier gas to convey the graphene-containing solids along the pipeline 26, and/or may comprise means for blending the graphene-containing solids 3 into a carrier gas 22 flow to provide the fluidised powder flow 24. For example, the carrier gas 22 may comprise a natural gas flow in a pipeline 26, wherein the conveying module comprises means to blend the graphene-containing solids as a fluidised powder into the natural gas flow in the pipeline 26. It will also be appreciated that, while system 1300 only shows one plasma reactor module, depending on desired output of products and the supply of feed gas 12, the system 1300 may comprise a plurality of plasma reactor modules configured to provide respective graphene-containing solids flows 3 (and optionally hydrogen-containing output gas flows 5) to the conveying module 20. A plurality of plasma reactor modules may for example be arranged in parallel as shown in FIG. 15.

FIG. 14 shows a schematic overview of a pipeline system 1400 comprising the system 1300 provided on an offshore platform 1401. The offshore platform 1401 is configured to obtain natural gas (though it will be appreciated that other hydrocarbons may alternatively or additionally be obtained) from a well 1402. Natural gas is provided to the plasma reactor module of system 1300 to produce graphene-containing solids as described previously. Electrical power to the plasma reactor module 1 may be provided by a green energy source such as one or more wind turbines 1410 (although it will be appreciated that the plasma reactor module may also receive electricity generated from the natural gas and/or the hydrogen-containing output gas, for example when the wind turbines are not producing sufficient energy). The system 1300 is configured to convey the graphene-containing solids, and optionally the hydrogen-containing output gas, via an export riser 1404 and through a natural gas pipeline 1406 to an on-shore facility 1408. The on-shore facility may comprise a separation module configured to separate the graphene-containing solids from the carrier gas. Where the carrier gas comprises natural gas, the separated carrier gas may provide a natural gas feed stream to one or more additional plasma reactor modules located at the onshore facility 1408 (optionally separating hydrogen from the carrier gas where present with a hydrogen separation module). In this way, existing infrastructure including offshore natural gas platforms and pipelines, may be used in combination with the present systems and apparatus to convert hydrocarbon fossil fuels such as natural gas into non-polluting hydrogen whilst also conveying valuable graphene-containing solids to an on-shore location. By using offshore wind power to power the system 1300, the system can advantageously be operated substantially without carbon emissions.

FIG. 15 shows a system 1500 in which three plasma reactor modules 1a, 1b and 1c are arranged in parallel to receive respective hydrocarbon feed streams 12a, 12b and 12c from a feed gas header 1508 coupled to a hydrocarbon source 8. Whilst not shown in FIG. 15, it will be appreciated that electrical power is also provided to the plasma reactor modules 1a, 1b and 1c. The three plasma reactor modules 1a, 1b and 1c produce respective hydrogen-containing output gas flows 5a, 5b and 5c, which are combined to provide a combined hydrogen-containing output gas flow 1505. The combined hydrogen-containing output gas flow 1505 may be provided directly downstream for use such as combustion, or for transport or storage. As will be appreciated, the hydrogen-containing output gas flow 1505 may be separated to provide hydrogen and hydrocarbon product streams as described previously herein. Separated hydrogen and hydrocarbon product streams may be used as described previously such as to provide recirculated hydrocarbons to the plasma reactor modules 1a, 1b and 1c, for example via the header 1508, or to provide power to the plasma reactor modules using hydrogen and/or hydrocarbons in the hydrogen-containing output gas flow 1505.

The graphene-containing solids flows 3a, 3b and 3c from the plasma reactor modules 1a, 1b and 1c, respectively, are combined to provide a combined graphene-containing solids flow 1503 that is conveyed by a graphene extraction module 1504 to a common graphene storage means 1502 such as a silo. The graphene extraction module 1504 may comprise any suitable means for drawing a fluidised powder flow of graphene containing solids from the plasma reactor modules, such as a vacuum system and optionally a cyclonic separation system 400 as described herein for separating carrier gas from the graphene containing solids that are provided to the common graphene storage means 1502.

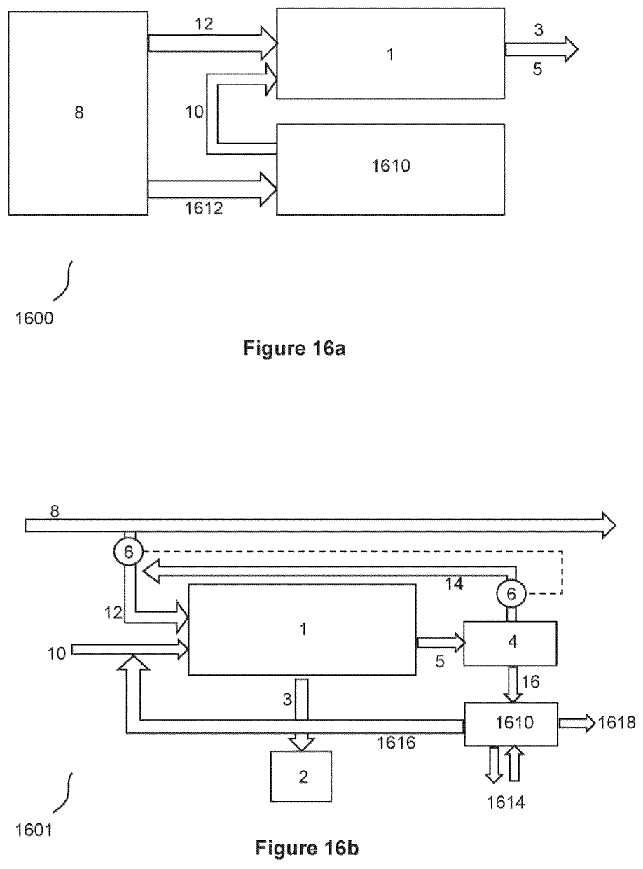

FIGS. 16a and 16b show systems 1600 and 1601 in which power for the plasma reactor module 1 is provided by, or supplemented with, power generated using fuel from the hydrocarbon source 8 or the hydrogen-containing output gas 5.

FIG. 16a shows a system 1600 comprising a plasma reactor module 1 arranged to receive a hydrocarbon feed stream 12 from a hydrocarbon source 8. The system comprises a power module 1610 configured to receive a hydrocarbon stream 1612 from the hydrocarbon source 8 and to produce electrical power using the hydrocarbon stream 1612, for example by combustion using a generator, a turbine or the like. The power module 1610 provides a source of electrical power 10 to the plasma reactor module 1. Although not shown in FIG. 16a, the power module 1610 may in some examples also receive hydrogen-containing output gas 5 from the plasma reactor module 1 for producing electrical power. The power module 1610 produces CO₂ by combusting hydrocarbons to produce power, which, despite this resulting in some carbon emissions, is more favourable than release of hydrocarbon gas, particularly methane, into the atmosphere. The plasma reactor module and power module 1610 can be portable containerised modules such that the system 1600 can be deployed easily to a point of use. As the system 1600 generates electricity for powering the plasma reactor module 1 using the hydrocarbon source 8 and the power module 1610, the system only requires a hydrocarbon input (such as a natural gas or methane supply) to operate. This allows the system 1600 to reduce harmful emissions at a site where hydrocarbons would otherwise be released or flared without energy cost, and as the system can be portable, the system can be moved to between locations to process excesses of hydrocarbon fuels in different locations as required (for example according to anticipated supply and demand).

Whilst FIG. 16a shows a combined flow of graphene-containing solids 3 and hydrogen-containing output gas 5, this is merely schematic and the system may convey, distribute, separate or use these flows separately as described previously. For example, if hydrocarbons remain in the hydrogen-containing output gas 5, these may be separated and recirculated to the feed stream 12 to avoid unnecessary carbon emissions. In addition, in some instances the plasma reactor module 1 and the power module 1610 may be combined as part of a single containerised apparatus.

FIG. 16b shows another system 1601 comprising a plasma reactor module 1 and a power module 1610. The plasma reactor module 1 receives a feed stream 12 from a hydrocarbon source 8 and produces graphene-containing solids 3 (which can be stored in storage means 2) and hydrogen-containing output gas 5. The hydrogen-containing output gas 5 is separated into hydrogen product stream 16 and a hydrocarbon product stream 14. The hydrocarbon product stream 14 is recirculated to the inlet of the plasma reactor module 1 and the hydrogen product stream 16 is provided to the power module 1610. The power module is configured to generate electricity supply 1616 that is used to provide electrical energy to the plasma reactor module 1 (for example with a combustion generator, a turbine or a hydrogen fuel cell). Optionally, the power module may also provide electrical energy 1618 to meet other demands, e.g. for use on-site or for providing electricity to meet an external demand. The power module 1610 may also generate waste heat during generation of electricity, which can be used in heat exchange 1614 with other systems to meet a heating demand and/or to provide cooling to the power module.

In the system 1601, when the electricity supply 10 to the plasma reactor module 1 (supplemented by the power module 1610) is derived from a renewable or green source, for example a carbon emission free source of electricity such as wind, solar, hydroelectric power etc., the system may be operated to process hydrocarbons into hydrogen and graphene without producing harmful emissions at the same time as producing graphene.

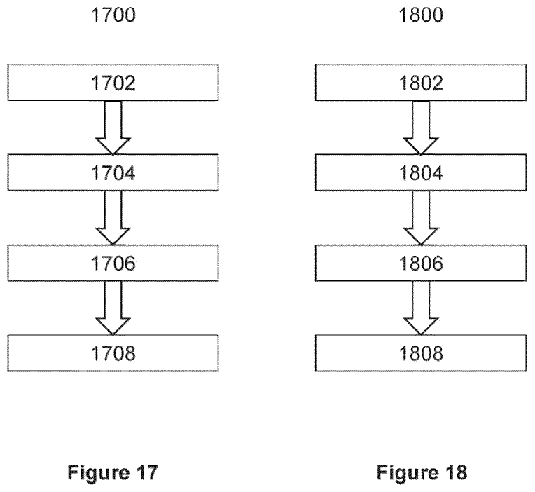

FIG. 17 shows a method 1700 for operating a portable containerised apparatus for producing hydrogen and graphene. The method comprises 1702 providing a process gas comprising hydrocarbons to a plasma reactor system within the containerised apparatus and 1704 producing hydrogen and graphene from the process gas in the plasma reactor system. At 1706 a hydrogen-containing output gas from the plasma reactor system is provided to a hydrogen outlet to allow the hydrogen-containing output gas to leave the containerised apparatus, and/or the hydrogen-containing output gas from the plasma reactor system is stored within the containerised apparatus, for example provided to hydrogen storage means within the containerised apparatus. At 1708 graphene-containing solids from the plasma reactor system are provided to a graphene outlet to allow the graphene-containing solids to leave the containerised apparatus, and/or the graphene-containing solids are stored within the containerised apparatus, for example the graphene-containing solids are provided to graphene storage means within the containerised apparatus.

FIG. 18 shows schematically a method of operating a portable containerised apparatus comprising a plasma reactor system for producing hydrogen and graphene. The method comprises 1802, operating the plasma reactor system to produce hydrogen and graphene from a process gas and 1804 separating the graphene from the hydrogen to provide hydrogen-containing output gas and graphene-containing solids. At 1806 the method comprises providing graphene-containing solids to a hopper coupled to a reaction chamber of the plasma reactor system, and 1808 extracting graphene-containing solids from the hopper to graphene storage means or to a graphene outlet from the containerised apparatus by isolating the hopper from the reaction chamber and extracting the graphene-containing solids from the hopper whilst continuing to produce graphene and hydrogen in the reaction chamber.

It will be appreciated that generally the apparatus referred to in relation to the methods described herein may comprise the apparatus 100 or a plasma reactor module 1 in a modular system, for example as shown in any of FIG. 1 to 16 or 20, and the method may comprise controlling the apparatus or system as described previously herein in relation to the controller (e.g. controller 110 or a control module). For example, the method may comprise operation of an apparatus 100 or a modular system with a controller 110 or a control module as described herein. For example, the methods may be implemented by the controller 110 or a controller of a control module according to instructions stored in a memory of the controller or remote instructions provided to the controller via a network. It will also be appreciated generally that apparatus features described herein may suitably be provided as method features, and vice versa.

It will also be appreciated that particular combinations of the various features described and defined in any aspects of the invention can be implemented and/or supplied and/or used independently. Other examples and variations will be apparent to the skilled addressee in the context of the present disclosure.

### SUMMARY OF ELEMENTS SHOWN IN THE FIGS

1—Plasma reactor module
2—Graphene storage module
3—Flow of graphene-containing solids
4—Hydrogen separation module
5—Flow of hydrogen-containing output gas
6—Pressure sensor
8—Hydrocarbon source
10—Power source
12—Feed stream
14—Hydrocarbon product stream
16—Hydrogen product stream
18—Reduced-carbon gas blend
20—Conveying module
22—Carrier gas source
24—Fluidised powder flow
26—Pipeline
100—Portable containerised apparatus
102—Plasma reactor system
104—Hydrocarbon storage
106—Gas compressor
107a—Microwave generator
107b—Waveguide
108—Hydrogen outlet
110—Controller
112—Attachment means
200—Reaction chamber
202—Curved side wall
204—Conical wall
206—Flat upper wall
210—Graphene removal port
212—Separation valve
214—Separation valve upper surface
300—Planar filter element
302—Filtration means
304—Gas outlet
306—Outer wall
308—Filter volume
310—Filter seal
312—Filter support
312a—Radial support struts
312b—Circular support struts
314—Central aperture
400—Scraper arm
402—Upper arm portion
404—Lateral arm portion
406—Lower arm portion
408—Angular gearbox
410—Servo motor
412—Shaft
500—Hopper
502—Air inlet
504—Purge gas inlet
506—Exhaust passage
600—Cyclonic separation system
602—Separator inlet passage
604—Cyclone inlet
606—Cyclone separation chamber
607—Chamber side wall
608—Cyclone solids outlet
610—Graphene storage container
612—Cyclone gas outlet port
614—Filter housing
616—Candle filter
618—Blowback valve
620—Vacuum valve
622—Flow of separated solids
624—Flow of separated gas
1401—Offshore platform
1402—Well
1404—Export riser
1406—Natural gas pipeline
1408—On-shore facility
1410—Wind turbines
1502—Common graphene storage
1503—Combined graphene-containing solids flow
1504—Graphene extraction module
1505—Combined hydrogen-containing output gas flow
1508—Feed gas header
1610—Power module
1612—Hydrocarbon stream to power module
1614—Heat exchange
1616—Power supply from power module
1618—External power supply from power module
2000—Plasma nozzle
2002—Plasma nozzle wall
2003—Taper
2004—Plasma finder
2005—Plasma afterglow
2006—Air knives
2007—Wave guide
2008—Dielectric tube
2009—Plasma

1. A portable containerised apparatus for producing hydrogen and graphene from a hydrocarbon source, the apparatus comprising:
a plasma reactor system configured to produce hydrogen and graphene from a process gas comprising hydrocarbons;
an inlet for receiving a feed stream comprising hydrocarbons from the hydrocarbon source and means for supplying the process gas to the plasma reactor system;
a hydrogen outlet for removing hydrogen from the containerised apparatus and/or hydrogen storage means within the containerised apparatus, and means for providing a hydrogen-containing output gas from the plasma reactor system to the hydrogen outlet and/or the hydrogen storage means; and
a graphene outlet for removing graphene-containing solids from the containerised apparatus and/or graphene storage means within the containerised apparatus, and means for providing graphene-containing solids from the plasma reactor system to the graphene outlet and/or the graphene storage means.

2. The apparatus according to claim 1, wherein the plasma reactor system comprises a reaction chamber, a plasma nozzle coupled to the reaction chamber and means for supplying the process gas to the plasma nozzle, optionally wherein the plasma reactor system comprises means for providing radio frequency radiation to the process gas within the plasma nozzle so as to produce a plasma within the plasma nozzle, and thereby cause cracking of hydrocarbons in the process gas within the plasma nozzle to provide cracked hydrocarbon species, wherein the plasma nozzle is arranged such that an afterglow of the plasma extends into the reaction chamber, the cracked hydrocarbon species also pass into the reaction chamber and recombine within the afterglow to provide graphene and hydrogen in the reaction chamber.

3. (canceled)

4. The apparatus according to claim 2, wherein the reaction chamber comprises a gas outlet configured to receive a hydrogen-containing output gas from the reaction chamber and a planar filter element arranged to separate the reaction chamber from the gas outlet, wherein the planar filter element is configured to prevent graphene-containing solids from entering the gas outlet, optionally wherein the planar filter element is disposed above the reaction chamber, optionally wherein the planar filter element extends across the reaction chamber to provide an upper wall of the reaction chamber.

5-6. (canceled)

7. The apparatus according to claim 4, wherein at least one of:
(i) the reaction chamber has a substantially flat upper wall, for example wherein the planar filter element provides at least a portion of the flat upper wall of the reaction chamber;
(ii) the planar filter element comprises a filtration means and a filter volume separating the filtration means from the gas outlet, the filter volume arranged above the filtration means to maintain an elevated temperature around the filtration means; or
(iii) the planar filter comprises a filter support configured to reduce or prevent deformation of the filtration means under pressure from the reaction chamber.

8-9. (canceled)

10. The apparatus according to claim 2, wherein the reaction chamber comprises a graphene removal port and the reactor system comprises a hopper configured to receive graphene-containing solids from the reaction chamber through the graphene removal port.

11. The apparatus according to claim 10, wherein at least one of:
(i) the graphene removal port is disposed below the reaction chamber;
(ii) the reaction chamber is tapered towards the graphene removal port; or
(iii) the graphene removal port comprises a separation valve configured to isolate the reaction chamber from the hopper, optionally wherein the separation valve provides a surface on which graphene-containing solids in the reaction chamber can collect when the separation valve is closed, for example whilst the hopper is emptied, the separation valve configured to permit the collected graphene-containing solids to enter the hopper when the separation valve is opened.

12-14. (canceled)

15. The apparatus according to claim 10, comprising means for extracting graphene-containing solids from the hopper to the graphene storage means or the graphene outlet, optionally wherein the means for extracting graphene-containing solids from the hopper comprises a cyclonic separator and a vacuum source configured to draw a gaseous suspension of the graphene-containing solids from the hopper to the cyclonic separator.

16-20. (canceled)

21. The apparatus according to claim 10, wherein the hopper comprises one or more gas inlets for receiving a flow of air and/or inert gas.

22. The apparatus according to claim 2, wherein the reaction chamber comprises a substantially cylindrical portion having a curved side wall and the plasma nozzle is disposed at a lower end of the curved side wall, optionally wherein the substantially cylindrical portion comprises at least one of:
(i) a filter at its upper end, optionally a planar filter element arranged to separate the reaction chamber from a gas outlet configured to receive a hydrogen-containing output gas from the reaction chamber, wherein the planar filter element is configured to prevent graphene-containing solids from entering the gas outlet; or
(ii) a graphene removal port at its lower end, optionally wherein the reaction chamber comprises a tapered portion extending from the lower end of the substantially cylindrical portion to the graphene removal port.

23-24. (canceled)

25. The apparatus according to claim 2, wherein the plasma reactor system comprises a scraper system for removing material that is deposited on an internal wall of the reaction chamber, optionally wherein the scraper system comprises a scraper arm configured to extend along, and contact, a side wall of the reaction chamber from an upper end to a lower end of the reaction chamber, wherein the scraper arm is operable to rotate about a longitudinal axis of the reaction chamber so as to move the scraper arm around the internal surface of the side wall.

26-27. (canceled)

28. The apparatus according to claim 2, wherein the reactor system comprises means for heating one or more internal walls of the reaction chamber to reduce or avoid precipitation of vapours in the reaction chamber on the one or more internal walls of the reaction chamber, optionally wherein the means for heating one or more internal walls of the reaction chamber comprises a heat pipe system for distributing heat generated by the recombination of cracked hydrocarbon species around the internal walls of the reaction chamber.

29. (canceled)

30. The apparatus according to claim 1, wherein the apparatus comprises means for recirculating hydrocarbons in the hydrogen-containing output gas to the plasma reactor system, optionally wherein the apparatus comprises means for blending recirculated hydrocarbons into the process gas, optionally wherein the means for recirculating hydrocarbons in the hydrogen-containing output gas is operable to control the proportion of hydrocarbons in the hydrogen-containing output gas that are recirculated to the plasma reactor system.

31. (canceled)

32. The apparatus according to claim 1, wherein at least one of:
(i) the hydrocarbon source comprises an external source of hydrocarbons and/or hydrocarbon storage means within the containerised apparatus, optionally wherein the hydrocarbon storage means is configured to store hydrocarbons received from an external source of hydrocarbons and to provide the stored hydrocarbons to the plasma reactor in the process gas;
(ii) the apparatus comprises a generator configured to provide electrical power to the apparatus using the feed stream comprising hydrocarbons and/or the hydrogen-containing output gas, optionally wherein the generator comprises a gas combustion generator and/or a hydrogen fuel cell; and
(iii) the apparatus comprising a regulator system configured to receive the feed stream comprising hydrocarbons and to control the pressure of the feed stream to provide the process gas to the plasma reactor system at substantially atmospheric pressure.

33-34. (canceled)

35. The apparatus according to claim 2, wherein the plasma nozzle is shaped and configured so as to cause at least one vortex to be formed in the process gas within the plasma nozzle, said vortex being subjected to said radio frequency radiation, optionally wherein the plasma nozzle is shaped and configured so as to cause multiple vortices to be formed in the process gas within the plasma nozzle, said multiple vortices being subjected to said radio frequency radiation.

36. (canceled)

37. The apparatus according to claim 2, wherein the means for supplying radio frequency radiation comprises a microwave generator, optionally further comprising a waveguide arranged to direct the radiation to the plasma nozzle.

38. (canceled)

39. The apparatus according to claim 1, wherein the plasma is generated at substantially atmospheric pressure.

40. The apparatus according to claim 1, wherein the feed stream comprising hydrocarbons comprises methane or natural gas, optionally wherein the hydrocarbons in the feed stream comprise one or more of CH₄, C₂H₆, C₂H₄, C₃H₈, or C₄H₁₀.

41-42. (canceled)

43. The apparatus according to claim 2, wherein in response to an activation signal, a controller is configured to control the apparatus to provide the process gas to the plasma nozzle, and to provide the radio frequency radiation to the process gas within the plasma nozzle so as to produce a plasma within the nozzle.

44. (canceled)

45. The apparatus according to claim 32, wherein a controller is configured to receive an indication of the pressure of the feed stream, such as from a feed pressure sensor, and to control the regulator system to regulate the pressure of the feed stream to provide the process gas at substantially atmospheric pressure.

46. The apparatus according to claim 11, wherein a controller is configured, in response to an indication to empty the hopper, to close the separation valve to isolate the reaction chamber from the hopper and to operate means for extracting graphene-containing solids from the hopper to the graphene storage means or the graphene outlet, optionally wherein at least one of:
(i) following extraction of graphene-containing solids from the hopper, the controller is configured to close an exhaust valve to isolate the hopper from the means for extracting graphene-containing solids from the hopper, and to open the separation valve to permit graphene-containing solids to enter the hopper from the reaction chamber, optionally wherein the hopper comprises an oxygen sensor, and the controller is configured to open the separation valve only in the event that the oxygen level is below a predefined threshold and/or wherein the hopper comprises a pressure sensor and the controller is configured to pressurise the hopper and to open the separation valve only in the event that a pressure drop in the hopper over a set period of time is below a predefined threshold;
(ii) the plasma reactor system is configured to continuously produce graphene and hydrogen during emptying of the hopper;
(iii) the indication to empty the hopper is provided by a sensor configured to provide the indication to empty the hopper when the amount of graphene-containing solids present in the hopper exceeds a predetermined threshold, or wherein the indication to empty the hopper is provided at predetermined time intervals during continuous operation of the plasma reactor system;
(iv) the controller is configured to purge hydrogen-containing gas from the hopper after isolating the hopper from the reaction chamber and prior to emptying the hopper of solids, and/or the controller is configured to purge the hopper with inert gas prior to re-opening the hopper to the reaction chamber; or
(v) the hopper comprises an oxygen sensor, and the controller is configured to open the separation valve only in the event that the oxygen level is below a predefined threshold and/or wherein the hopper comprises a pressure sensor and the controller is configured to pressurise the hopper and to open the separation valve only in the event that a pressure drop in the hopper over a set period of time is below a predefined threshold.

47-51. (canceled)

52. The apparatus according to claim 2, wherein the reaction chamber comprises an oxygen sensor, and a controller is configured to control the plasma reactor system to produce a plasma within the plasma nozzle only in the event that the oxygen level is below a predefined threshold; and/or wherein a controller is configured to purge the reaction chamber with an inert gas or the process gas prior to controlling the reactor system to produce a plasma within the plasma nozzle.

53-54. (canceled)

55. The apparatus according to claim 1, wherein the plasma reactor system comprises one or more pressure sensors, and in response to the activation signal a controller is configured to pressurise the plasma reactor system and to control the plasma reactor system to produce graphene and hydrogen only in the event that a pressure drop in the system, for example optionally a pressure drop in the reaction chamber, over a set period of time is below a predefined threshold.

56. The apparatus according to claim 1, comprising a communications interface configured to provide network access to a controller, for example wherein the controller is configured to use the communications interface to provide remote access to analytical information such as sensor data and/or to receive control signals remotely via the network.

57. The apparatus according to claim 1, comprising a Raman spectrometer configured to analyse the graphene-containing solids, optionally wherein a controller is configured to at least one of:
(i) control operation parameters of the plasma reactor system based on the Raman analysis of the graphene-containing solids, optionally based on a quality rating of the graphene based on peak intensity ratios, peak width and/or peak position data in the Raman spectrum;
(ii) send an alert to an operator, to shut down the plasma reactor system, and/or to trigger an automated optimisation process in response to an indication that the graphene quality is below a predefined threshold; or
(iii) trigger an automated optimisation process comprising modifying one or more process parameters whilst monitoring Raman analysis of the graphene-containing solids to determine a change to graphene quality, optionally wherein the one or more process parameters comprises one or more of: gas flow rates into and out from the reaction chamber, reaction chamber or process gas pressure, and power of the radio frequency radiation, optionally wherein in the event that graphene quality is increased by the optimisation process, the controller is configured to store the optimised process parameters.

58-62. (canceled)

63. The apparatus according to claim 1, wherein the graphene outlet comprises the hydrogen outlet, optionally wherein the graphene containing solids are conveyed from the containerised apparatus by a carrier gas comprising at least a portion of the hydrogen containing output gas.

64. The apparatus according to claim 1, wherein the apparatus is contained within an intermodal container, optionally wherein the intermodal container is at least one of:
(i) a shipping container in accordance with ISO standard 668:2020; or
(ii) a container having a height of 3.0 m or less, a width of 2.5 m or less, and/or a length of 14 m or less.

65-75. (canceled)

76. A method of operating a portable containerised apparatus for producing hydrogen and graphene, comprising:
providing a process gas comprising hydrocarbons to a plasma reactor system within the containerised apparatus, the plasma reactor system configured to produce hydrogen and graphene from the process gas;
providing a hydrogen-containing output gas from the plasma reactor system to a hydrogen outlet for removing hydrogen from the containerised apparatus and/or to hydrogen storage means within the containerised apparatus; and
providing graphene-containing solids from the plasma reactor system to a graphene outlet for removing graphene from the containerised apparatus and/or to graphene storage means within the containerised apparatus.

77-92. (canceled)

93. A modular system for producing hydrogen and graphene from a hydrocarbon source, the system comprising a plurality of modules each configured to cooperate with one or more of the other modules, the modules comprising:
a portable containerised apparatus according to claim 1, configured to receive hydrocarbons from the hydrocarbon source and to provide a hydrogen-containing output gas and graphene-containing solids; and
at least one of:
a power module configured to receive hydrocarbons from the hydrocarbon source and/or the hydrogen-containing output gas and to provide electrical power, for example to provide electrical power to one or more other modules of the plurality of modules;
a hydrogen separation module configured to receive the hydrogen-containing output gas and to separate hydrogen from hydrocarbons in the hydrogen-containing output gas;
a further plasma reactor module;
a module configured to receive the graphene-containing solids and a carrier gas, such as the hydrogen-containing output gas or a hydrocarbon-containing gas from the hydrocarbon source, and to convey the graphene-containing solids along a pipeline as a fluidised powder using the carrier gas;
a module configured to receive graphene-containing solids as a fluidised power in a carrier gas, and to separate the graphene from the carrier gas;
a graphene collection module comprising a vacuum source and a cyclonic separator configured to extract graphene-containing solids from at least one plasma reactor module in a carrier gas using the vacuum source, and to separate the graphene-containing solids from the carrier gas in the cyclonic separator to store the graphene-containing solids;
a control module comprising a controller configured to communicate electronically, for example via a network, with one or more other modules of the plurality of modules to control operation of the other modules and/or to provide remote network access to analytical information such as sensor data;
a quality control module configured to receive graphene-containing solids, and comprising a Raman spectrometer configured to analyse the graphene-containing solids to determine a quality of graphene that is present;
a hydrogen storage module configured to receive a hydrogen-containing output gas from one or more other modules and to store the hydrogen, such as by compression;
a graphene extraction module configured to extract graphene-containing solids from one or more plasma reactor modules, and to provide the graphene-containing solids to an external graphene storage means; and
a graphene storage module configured to receive and store graphene-containing solids from one or more other modules;
optionally wherein the plurality of modules are portable containerised modules wherein each module is optionally contained within an intermodal container.

94-97. (canceled)

98. A system for producing a reduced-carbon gas blend from a hydrocarbon gas supply flow, comprising:
a portable containerised apparatus according to claim 1, configured to receive a feed stream comprising hydrocarbons, the feed stream comprising a portion of the hydrocarbon gas supply flow, and to provide a hydrogen-containing output gas and graphene-containing solids; and
means for blending at least a portion of the hydrogen-containing output gas into the hydrocarbon gas supply flow to provide a reduced-carbon gas blend.

99-104. (canceled)

105. A system for transporting graphene through a pipeline comprising:
a portable containerised apparatus according to claim 1 configured to receive hydrocarbons from a hydrocarbon source and to provide a hydrogen-containing output gas and graphene-containing solids;
means for blending the graphene-containing solids with a carrier gas and conveying the graphene-containing solids through a pipeline as a fluidised powder using the carrier gas;
optionally wherein the carrier gas comprises at least a portion of the hydrogen-containing output gas or a hydrocarbon-containing gas from the hydrocarbon source.

106-109. (canceled)
